(19) United States
(12) Patent Application Publication
(10) Pub. No.: US 2020/0151752 A1
(43) Pub. Date: May 14, 2020

(54) System and method for acquiring consumer feedback via rebate reward and linking contributors to acquired feedback

(71) Applicant: Aliaksei Kazlou, Mesa, AZ (US)

(72) Inventor: Aliaksei Kazlou, Mesa, AZ (US)

(21) Appl. No.: 16/680,436

(22) Filed: Nov. 11, 2019

Related U.S. Application Data
(60) Provisional application No. 62/760,002, filed on Nov. 12, 2018.

(51) Int. Cl. G06Q 30/02; G06Q 30/06

(52) U.S. Cl. CPC G06Q 30/0217; G06Q 30/0282; G06Q 30/0643; G06Q 30/0234; G06Q 30/0213; G06Q 30/0239

(57) ABSTRACT

A reputation network system includes a reputation network server and at least one reputation network device; such that a listing owner store a product listing, including a feedback rebate offer; such that a contributor user store a contribution record related to the product listing; such that a consumer user purchases the product and creates a product review on the reputation network server; such that that the consumer redeems the feedback rebate offer after providing the product review. Also disclosed is a reputation network method, including creating a product listing, creating a contribution record, purchasing the product, creating a product review, and redeeming feedback rebate.

### CROSS-REFERENCE TO RELATED APPLICATIONS

This application claims the benefit of U.S. Provisional Application No. 62/760,002, filed Nov. 12, 2018; which is hereby incorporated herein by reference in its entirety.

### FIELD OF THE INVENTION

The present invention relates generally to the field of systems and methods for acquiring and using online reputation, and more particularly to methods and systems for using a sale incentive, conditional upon feedback in a reputation network setting, to generate high-quality feedback and link that feedback to employees and their profiles.

### BACKGROUND OF THE INVENTION

There are currently many companies that help businesses gather, aggregate, and display consumer feedback (e.g., product reviews) for products and services. A few examples are AMAZON™, YELP™, GOOGLE™, TAOBAO™, ANGIE'S LIST™, YOTPO™, BAZAARVOICE™, POWERREVIEWS™, TRUSTPILOT™, and Feefo™. These companies will be referred to as “reputation providers” in the following disclosure.

Content-based reputation platforms, such as Facebook, Twitter, LinkedIn, YouTube, Stack Overflow, among many others, allow their users to upload content and receive feedback from users who consume that content. This feedback comes in the form of various content reviews and tokens, such as “likes,” comments, shares, followers, votes, etc. The collected feedback contributes not only to the reputation of the content itself but also to the reputation of the individuals who created that content. For example, a person who consistently posts high-quality content and receives positive feedback will typically improve their own reputation as a content creator. Because the content and its creators are so inextricably linked, the direct feedback from the content consumers is a powerful motivator to create and post high-quality content on content-based platforms and networks.

Similar to content-based platforms, most e-commerce platforms, such as Amazon, allow their users to create and post web-listings for products and services and receive direct feedback from consumers, typically via customer reviews. These reviews contribute to the reputation of the product or service and the corresponding brand/company. However, unlike content feedback, product reviews do not contribute to the reputation of individual employees who created the product. For example, an engineer who consistently builds high-quality home appliances doesn't currently have a way of receiving direct consumer feedback and establishing his or her reputation, even though their products may be used by many people and receive many reviews on e-commerce platforms. Because the product and the employees who created it are not linked, the direct feedback from consumers lacks the power to engage and motivate employees.

Customers currently lack an ability to learn about and “follow” people who created their products or provided their services. When we decide to consume a piece of content, such as a book or a movie, it is often very important for us to know who the author, the director, and the actors are. The brands of the production or the publishing company are usually less important and often completely irrelevant.

Contrast that with products and services. When we decide on buying something other than content, such as a new kitchen appliance, a haircut, or a restaurant meal, we chose almost exclusively among brands and not engineers, hairdressers, or cooks. As in movies, a brand reputation is sometimes a very poor predictor of the final product's quality. For example, the reputation of a particular hairdresser would be far more relevant for a potential consumer than the brand reputation of the company that currently employs that hairdresser. As consumers, we could be better served by being able to see the people behind the brands and their reputation. This would not only help us make better purchasing decisions but also allow us to learn about and connect with individuals whose products and services affect our everyday lives.

Employers who seek to hire qualified employees currently rely heavily on subjective opinions of past managers, self-promoting resumes, and often biased and misleading person-to-person interviews. These hiring practices often produce poor results and are time consuming and expensive. A hiring manager may spend months searching through resumes, interviewing dozens of candidates and still make a poor decision because of the subjective and manual nature of the hiring process. For example, an average engineer, who is an excellent self-promoter and of the same age and gender as the hiring manager, may be chosen over someone who is an excellent engineer but doesn't have much in common with the hiring manager. Discrimination and bias are rampant in corporate environments, even when hiring managers are aware of them and trying to do everything they can to be objective.

Contrast that with the search for a content creator. One could easily and quickly rank thousands of content creators in a matter of seconds, group them by the specific field of interest and the type of content they create. There is no bias because the reputation is based in large part on independent consumer feedback (e.g., “likes,” shares, followers, views, votes). This digitized and aggregated feedback gives anyone an ability to quickly determine exactly whose content has the best reputation in a particular field with a very high degree of confidence.

In the world of content, the company reputation, as well as the reputation of its content, can improve if the company hires great content creators and shares that fact with potential customers. For example, a reputation of a production company, as well as the reputation of the product (e.g., movie), is improved if a highly-skilled and famous actor joins its cast. This transparency can potentially benefit companies outside content-related industries as well, but there is currently no technological solution to easily be able to showcase product's contributors and their talents.

In this disclosure, we will introduce a technological solution capable of linking independent consumer feedback (e.g., product reviews) to employee contributions, and providing a quick and easy way to find and rank individual contributors for a particular job role.

Consumer feedback (e.g., reviews) is one of the most important factors potential customers consider before making their purchasing decisions. However, the currently available solutions available to businesses for capturing customer reviews are often inadequate, expensive, bias, and ineffective. In the absence of any incentive from the company, on average, less than one percent of customers leave a review. The reviews also tend to be negative because satisfied customers typically don't have a compelling reason to leave a positive review. The dissatisfied customers, on the other hand, are often driven by the feeling of vindication and justice and are far more likely to leave a review. As a result, a good and honest business may receive a disproportionate amount of negative reviews and earn a poor reputation. This situation is further aggravated due to the lack of transparency and independent verification of reviews, which opens an opportunity and provides an incentive for cheating. Companies such as YELP™, AMAZON™, GOOGLE™, and other reputation providers, discourage cheating in their terms of service but provide woefully inadequate solutions for enforcing their rules.

Lack of transparency and adequate enforcement creates a runaway effect where even good and honest businesses are forced to cheat. For example, a restaurant business serving hundreds of customers, a vast majority of whom are satisfied, may naturally receive only one review a month, which will tend to be negative. A competing restaurant across the street may employ a less ethical practice of asking only satisfied customers for a review on YELP™ and even offering them a free dessert, clearly violating the YELP™ terms of service. The competing restaurant would be more likely to receive a better reputation, even if it doesn't actually provide superior service. The likelihood of YELP™ discovering the wrongdoing and being able to enforce their rules is far lower than the benefits the cheating provides. Considering how important reviews are to potential customers, the “honest” restaurant is likely to experience a significant negative impact on its business, unless its reputation practices are changed to match the competitor's.

This problem affects not only restaurant owners and their customers but also most other kinds of businesses. According to multiple online surveys, most people have experienced a “bribe” by receiving an email asking them for a review in exchange for a free or discounted product, or by receiving a review request after a clearly positive experience. Companies like GOOGLE™, AMAZON™, and YELP™ spend significant resources to make gathering reputation less prone to bias, but no viable solution currently exists to solve this problem.

Another problem without a clear solution is the quality of the consumer feedback. Consumers may, and often do leave disrespectful, uninformative, inconsiderate, or false reviews for a product or service. The ability to leave anonymous reviews or have multiple accounts allows people to avoid any personal responsibility for their comments online. Without a clear link between the individual's professional profile and their consumer activity, poor-quality feedback has no repercussions for personal reputation. For companies, monitoring and counteracting such behaviors is often a manual process requiring significant human and technological resources and is rarely scalable or effective.

Because the risk of fraudulent feedback (“fake reviews”) is so high, the current solutions prevent the same individual from leaving multiple reviews for the same product, even if that individual is a repeat customer. This may cause long-term effects not to be captured in the feedback, which may lead to misrepresentation of the product's real quality. For example, a merchant selling dietary supplements may receive one-time reviews from multiple buyers who′d feel the short-term positive effects and leave positive reviews. Some of those customers, who continue to buy and use the supplements over an extended period, may potentially experience long-term negative side-effects. Because they have already left a onetime positive review in the past, they won't be asked by the merchant to leave a review again, or may even be actively prevented from doing so by the reputation provider the merchant uses (e.g., AMAZON™, YELP™, GOOGLE™). This situation disproportionately favors short-term focus and may provide misleading and even dangerous, assurance of the product's quality. Therefore, honest reviews from repeat customers can often be more representative of the product's quality and provide more reliable information to potential customers than one-time reviews.

Currently, the frequency of purchases, the number of times the product was purchased, and the amount of money spent, are not typically considered by reputation providers in their solutions. In other words, a review from a customer who purchased the product once at a severely discounted price has the same weight as a review of a customer who had been buying the product dozens of times at a full price over a long period. Most likely, the second customer would know more about the product and would have spent more time and money to earn that knowledge than the first customer. Therefore, the review from the second customer should “weigh” more than the review from the first customer.

Similarly, a potential customer (first customer) buying a large quantity of the product is risking more resources than a potential customer (second customer) buying a small quantity. The first customer will need more assurance that the product is of a high-quality than the second customer. The knowledge that the potential future review will have a larger effect on the product's reputation, as well as the knowledge that the business is aware of that effect, may provide the first customer a greater quality assurance, which, in turn, may lead to larger sale orders for the business and better-functioning marketplace.

Most current reputation providers allow one individual to have multiple accounts. We believe that in order for customers to feel personal responsibility for the content of their reviews, one-person-one-account policy should be enforced and their reputation as a customer linked to their professional reputation. On the reputation network system, even if a customer has only two accounts, for example, he or she can use one to leave good-quality reviews and maintain a good reputation and use another account to leave poor-quality or fake reviews without any repercussions to their own reputation. In the present implementation, the reputation network system uses a variety of verification techniques to enforce the one-person-one-account policy.

These techniques include but are not limited to email and mobile phone verification.

Most current reputation providers allow businesses to offer incentives (e.g., gift card, discount, free product) for customer reviews. Although such incentives are effective at generating large quantities of reviews, they are also very inefficient, expensive and tend to introduce a significant amount of bias. Multiple empirical studies analyzing reviews on AMAZON™ and other platforms concluded that review incentives produce biased reviews. Many factors can contribute to the bias.

First, customers feel the need to reciprocate when given something of value. It goes against our human nature to criticize something that was given to us as a favor.

Second, customers may fear retaliation from the business for leaving negative feedback. For example, a company may stop offering discounts and special offers to customers who had left a negative review in the past.

Third, it's illegal in many countries not to clearly disclose to potential customers the fact that the reviews were incentivized. With such disclosure in place, the perceived trustworthiness and, therefore, the value of reviews is significantly reduced.

Fourth, even if a third-party, such as AMAZON™, take control over who gets the incentives and when (e.g., AMAZON'S™ VINE™ program) not all customers will be equally incentivized. This may lead to over-reliance on AMAZON'S™ algorithms to determine the fate of a product's reputation. Finally, such programs are excessively expensive to run effectively, especially for new businesses that don't yet have a lot of resources and need the feedback the most. Inadequate investment in the review incentive program may produce too small of a sample size to be statistically significant for judging product's reputation. Although a new business with low sales volume may afford to offer a small discount to increase sales, an additional after-the-sale review incentive, which typically needs to be much larger, may be too expensive. Review incentives often require the business to offer half-off discounts or even give away free products to achieve the desired response rate. Incentive must be large enough to not only convince customers to leave a review but also to convince them to use the offered discount code or gift-card to buy again; otherwise, customers will see no value in the incentive. In other words, paying more money for review incentives is not a viable solution for a lot of businesses, even when it is administered by a third-party.

Discounts and other sales incentives are useful tools for temporarily increasing sales and attracting new customers. However, they also carry many negative side-effects for the business as well.

First, a discounted product is often perceived by potential customers as inferior, undesirable, or not worth the cost. The reason is, if the product were superior and relatively more desirable, there wouldn't be a need for a discount.

Second, a discount is a direct reduction in profit. In other words, if the product were sold at a full price instead, the profit would have been higher by the exact amount of the discount. Most businesses rely on a particular profit margin to compete successfully in the marketplace. A lot of effort goes into reducing fixed and variable costs to increase the profit margin. Hence, offering discounts may prevent the business from being profitable.

Third, more and more customers come to expect products to be discounted and won't buy unless they get a great deal. Often this great deal robs the business of its profit and sets an even greater and more unreasonable price expectation.

Thus, in conclusion, current content-based platforms provide users with a system to acquire reputation but only for their content; whereas current ecommerce platforms provide users with a system to acquire the reputation for their products and services but not people who created them. As a result, companies struggle to engage employees and improve their hiring decisions. A resume remains the standard for assessing someone's professional reputation and legacy today. Current solutions for gathering customer feedback are inadequate, biased, expensive, and insufficient for building a fair reputation in a marketplace. Hence, there is a need for a reputation network that is not limited to content and provides a way for all people in all professions to earn reputation via direct, honest, reliable, and high-quality feedback from consumers.

As such, considering the foregoing, it may be appreciated that there continues to be a need for novel and improved devices and methods for acquiring consumer feedback with rewards and contributor attribution, including an effective and efficient solution to provide all customers with an equal incentive to leave honest reviews without any additional cost to the business or any inherent bias.

### SUMMARY OF THE INVENTION

The foregoing needs are met, to a great extent, by the present invention, wherein in aspects of this invention, enhancements are provided to the existing model for acquiring consumer feedback with rewards and contributor attribution.

In an aspect, a reputation network system can include:
a) a reputation network server; and
b) at least one reputation network device;
wherein the reputation network server enables a listing owner user to store a product listing for a product, in communication via the at least one reputation network device; wherein the product listing includes product information and a feedback rebate offer;
wherein the reputation network server enables a contributor user to store a contribution record in relation to the product listing, in communication via the at least one reputation network device; wherein the contribution record includes contribution information; and
wherein the reputation network server enables a consumer user to purchase the product and store a product review on the reputation network server, in communication via the at least one reputation network device; such that the consumer user is enabled to redeem the feedback rebate offer and receive a corresponding feedback rebate after providing the product review.

In a further related aspect, the reputation network server can further include a reputation database, including:
a) a listing data entity, including product listing records, which include the product listing;
b) a contribution data entity, which includes contribution records relating a contributing user to a product listing,
c) a feedback data entity, which includes feedback records for storing feedback of the consumer user in relation to product listing records; and
d) a user data entity, including user information records.

In a yet further related aspect, the reputation database can further include a role entity, which stores role records, each including an average reputation rank.

In a yet further related embodiment, the reputation database can further include a joint role tag entity, which stores role tag records, which link role records with contribution records, listing records, and contribution records.

In a related aspect, the reputation network server can calculate a relative weight for the product review, wherein the relative weight is equal to a number of products purchased.

In another related aspect, the reputation network server can calculate a product listing relative reputation rank and a contribution relative reputation rank.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. In addition, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a schematic diagram illustrating a reputation network system, according to an embodiment of the invention.

FIG. 2 is a schematic diagram illustrating a reputation network device, according to an embodiment of the invention.

FIG. 3 is a schematic diagram illustrating a reputation network server, according to an embodiment of the invention.

FIG. 4 is a schematic diagram illustrating an entity relationship diagram for listing records of the reputation network system, according to an embodiment of the invention.

FIG. 5 is a flowchart illustrating steps that may be followed, in accordance with one embodiment of a method or process of updating a contribution record.

FIG. 6 is an illustration of a graphical user interface for a contribution form, according to an embodiment of the invention.

FIG. 7 is an illustration of a graphical user interface for an email invitation, according to an embodiment of the invention.

FIG. 8 is an illustration of a graphical user interface for a contribution edit form, according to an embodiment of the invention.

FIG. 9 is an illustration of a graphical user interface for a product listing page, according to an embodiment of the invention.

FIG. 10 is an illustration of a graphical user interface for a contributor profile page, according to an embodiment of the invention.

FIG. 11 is an illustration of a graphical user interface for a product review, according to an embodiment of the invention.

FIG. 12 is a flowchart illustrating steps that may be followed, in accordance with one embodiment of a method or process of processing reputation rank.

FIG. 13 is a schematic diagram illustrating an entity relationship diagram for listing records of the reputation network system, according to an embodiment of the invention.

FIG. 14 is a flowchart illustrating steps that may be followed, in accordance with one embodiment of a method or process of updating feedback rebate settings.

FIG. 15 is a flowchart illustrating steps that may be followed, in accordance with one embodiment of a method or process of generating a feedback rebate record.

FIG. 16 is a flowchart illustrating steps that may be followed, in accordance with one embodiment of a method or process of redeeming a feedback rebate.

FIG. 17 is an illustration of a graphical user interface for a feedback rebate settings form, according to an embodiment of the invention.

FIG. 18 is an illustration of a graphical user interface for a scheduled rebate notification, according to an embodiment of the invention.

FIG. 19 is an illustration of a graphical user interface for a customer profile page, according to an embodiment of the invention.

FIG. 20 is an illustration of a graphical user interface for a product listing page, according to an embodiment of the invention.

FIG. 21 is an illustration of a graphical user interface for a business listing page, according to an embodiment of the invention.

FIG. 22 is a flowchart illustrating steps that may be followed, in accordance with one embodiment of a reputation network method or process.

### DETAILED DESCRIPTION

Before describing the invention in detail, it should be observed that the present invention resides primarily in a novel and non-obvious combination of elements and process steps. So as not to obscure the disclosure with details that will readily be apparent to those skilled in the art, certain conventional elements and steps have been presented with lesser detail, while the drawings and specification describe in greater detail other elements and steps pertinent to understanding the invention.

The following embodiments are not intended to define limits as to the structure or method of the invention, but only to provide exemplary constructions. The embodiments are permissive rather than mandatory and illustrative rather than exhaustive.

All references to “product” or “product and service” herein shall be understood to include all other possible manifestations of value, such as for example events, programs, lessons, experiences, etc.

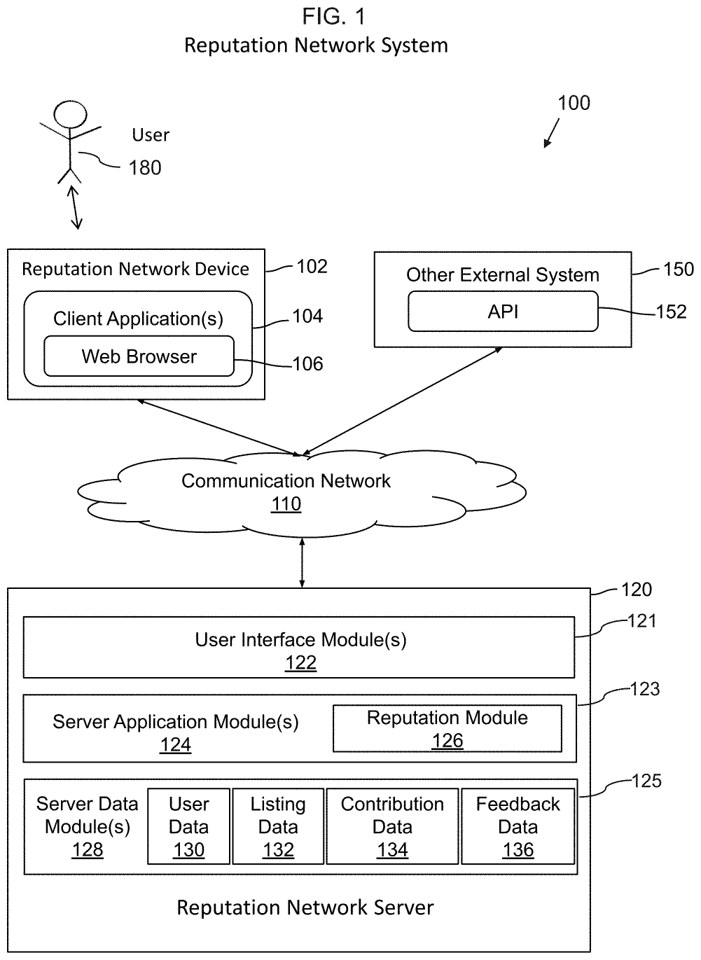

In the following, we describe the structure of an embodiment of a reputation network system 100 with reference to FIG. 1, in such manner that like reference numerals refer to like components throughout; a convention that we shall employ for the remainder of this specification.

In various embodiments, the reputation network system 100 can provide system and methods for gathering and attributing consumer feedback about products and services to individual contributors of those products and services, then using that feedback for creating more objective measures of contributor performance and reputation.

In related embodiments, other platforms, such as an existing social network, content-sharing network, ecommerce platform, or directory can be modified to support the reputation network system 100.

In a related embodiment, the reputation network system 100 can include two methods that work together to provide maximum value for users of the invention. These two methods can be used separately and provide some of their potential benefits, but they work best within the integrated reputation network system. These two methods will be referred to herein as “role contribution” and “feedback rebate.”

Role contribution can include a method for creating a contribution record connecting contributors with their products and services. This contribution record enables the attribution of consumer feedback about product and services to people who contributed to those products and services.

Feedback rebate can include a sale incentive offered indiscriminately to potential consumers and conditional upon both the sale and the consumer's honest feedback (e.g., review).

In related embodiment, reputation network system 100 will be explained by first comparing it to the existing and well-known technologies and methods of building an online reputation in content-based and ecommerce environments. Although the disclosed invention provides unique technological solutions, comparing it to existing technologies may serve as a starting point and improve understanding of the invention and its unique features.

Social media networks, such as FACEBOOK™, TWITTER™, STACKOVERFLOW™, and LINKEDIN™, are content-based reputation networks. In order to earn a good reputation on these networks, a user must create and share a high-quality content that is likely to receive positive feedback from the content consumers. In this context, the “quality” of the content is determined by the amount and nature (i.e., positive or negative) of feedback it receives, not necessarily the production value of the content. Depending on the network, the feedback can come in the form of “likes,” comments, shares, votes, tokens, karma, to give just a few examples. This feedback also helps users to increase their influence and audience reach by acquiring subscribers, also known as followers.

The process of acquiring reputation and influence through direct feedback is the primary incentive for some people to create high-quality content for free, even when it requires spending substantial time, money, and effort to do so. The presence of content-based networks that are designed to facilitate the gathering of direct feedback from content consumers has resulted in a treasure trove of videos, tutorials, articles, and answers freely shared on the internet and only a few clicks away for anyone to enjoy.

It is also relatively easy for an outside observer to determine the quality of content any particular user creates and the level of influence and reputation they have earned in a network compared to other users. Hence, instead of collecting resumes, calling references, and conducting interviews, any company or individual today can easily rank content providers and more objectively determine their reputation by the type of content they create and the number of views, “likes,” comments, shares, followers, votes they receive.

Content creators bring a lot of value into people's lives through their content, but so do people who provide us with other manifestations of value (e.g., products and services). Our home appliances, restaurant meals, furniture, gadgets, government services, groceries, and clothes, just to name a few, are all created and provided for us by designers, engineers, cooks, project managers, farmers, manufacturers, etc. Names and contributions of these employees are typically hidden from consumers behind brands and labels. The direct feedback in the form of customer reviews is often linked with the product but not with the individuals who created it. In the absence of objective criteria to judge the skill level and reputation of these employees, they are often judged and compensated according to their self-promoting, resume-writing, and interview-giving skills, which most of the time have nothing to do with their actual jobs. Understandably, companies who hire these employees struggle to engage and motivate them even after increasing salaries and improving company culture and leadership.

In various embodiments, the reputation network system 100 provides a solution to this problem by using computer and web technologies to facilitate gathering consumer feedback for all manifestations of value (not only content) and attributing that feedback not only to the product and the company but also to the individual contributors.

In related embodiments, the reputation network system 100 can include four main actors and their roles, such that different parts of the system interact to help each actor achieve their particular goal. Generally, a single user 180 of the reputation network system 100 can play any of the four roles described below at any time. The main actors include:
a) A listing owner 180 is an individual whose primary goals are to promote her products and engage her employees;
b) A contributor 180 is an individual whose goal is to receive direct feedback from consumers and build his professional reputation;
c) A consumer 180 is an individual whose goal is to purchase the best product for the best price; and
d) An employer 180 is an individual whose goal is to obtain an objective measure of a potential employee's past performance (i.e., reputation) based in part on customer feedback.

Before the technical process and interactions between computer and web-technology components are explained, the reputation network system 100 will be described at the level of user interactions. These are only example use cases of the invention created to make later technical disclosure easier to understand.

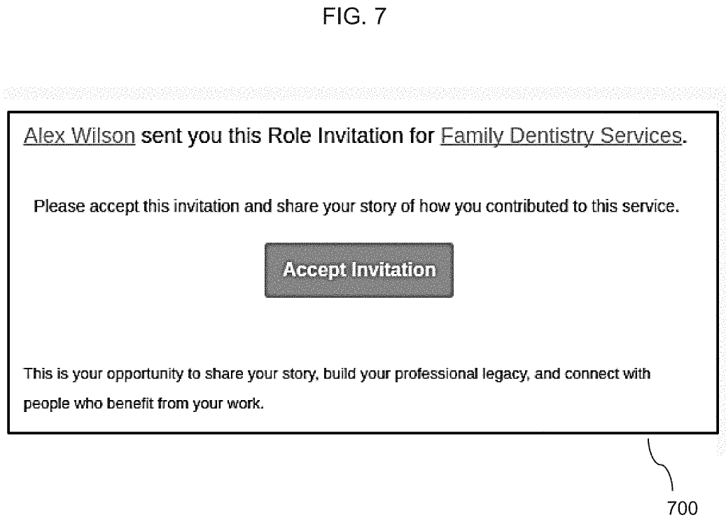

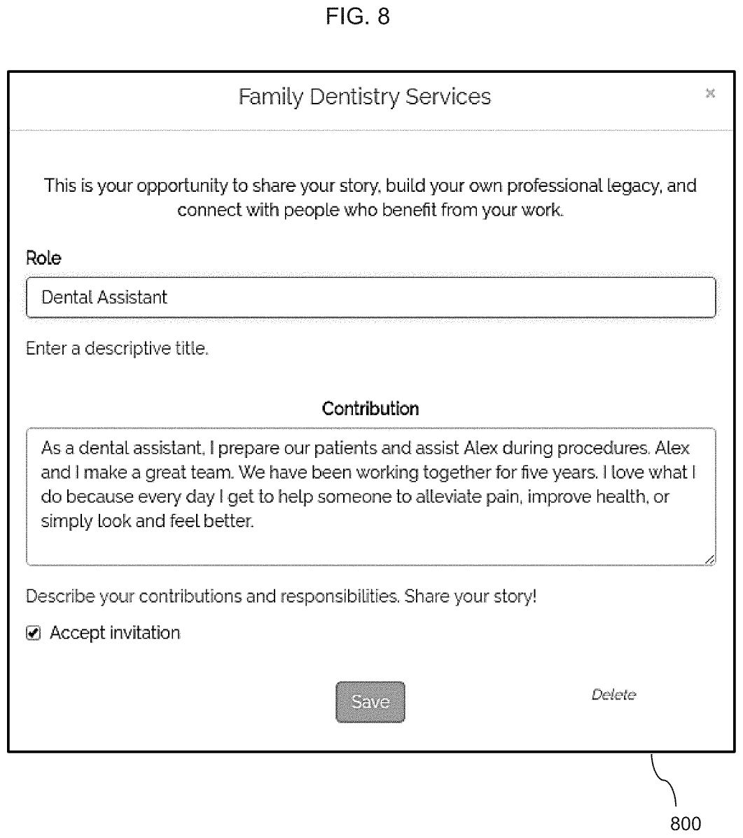

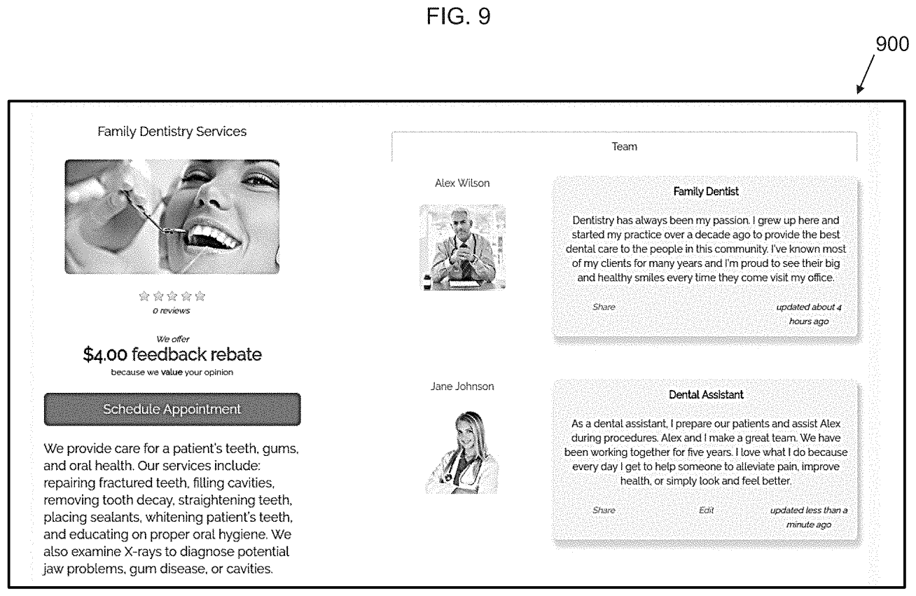

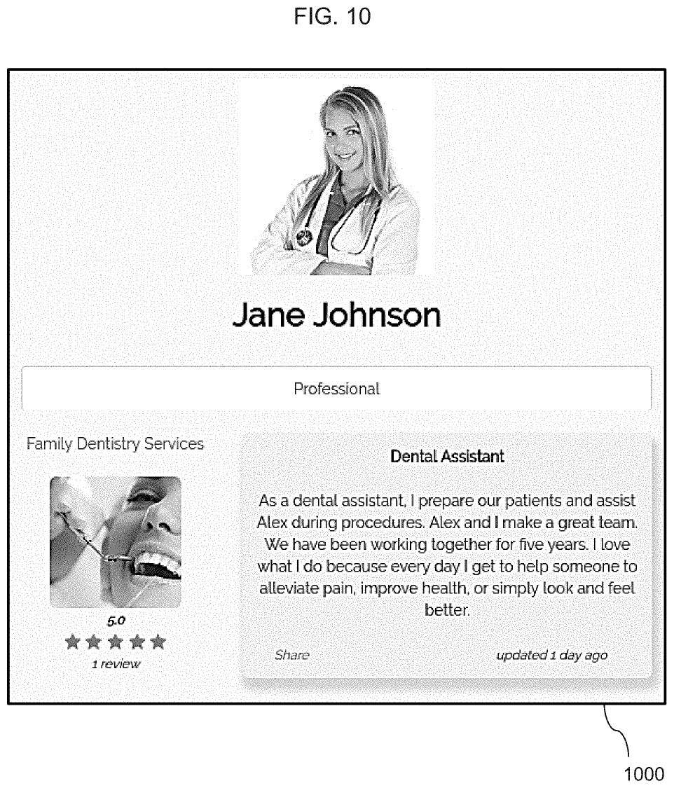

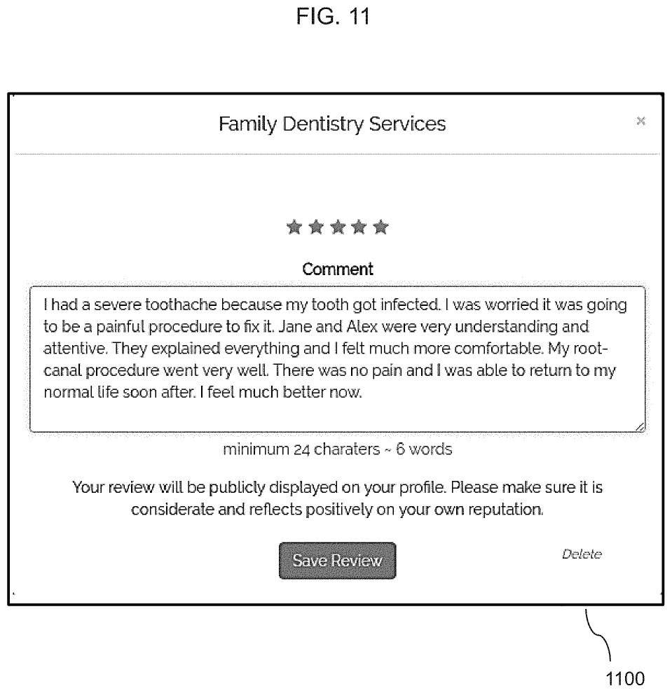

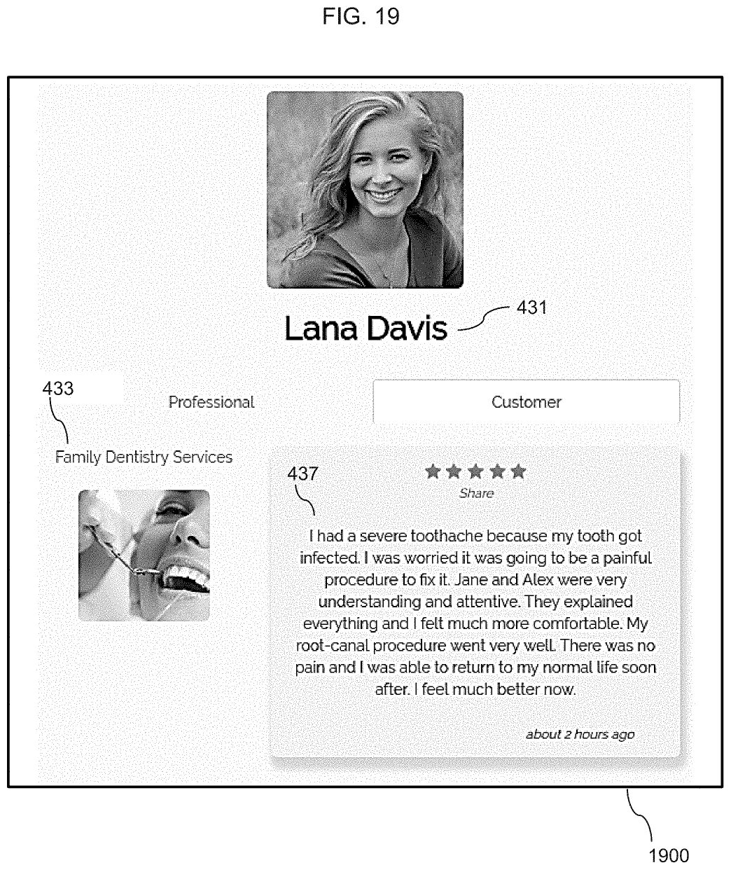

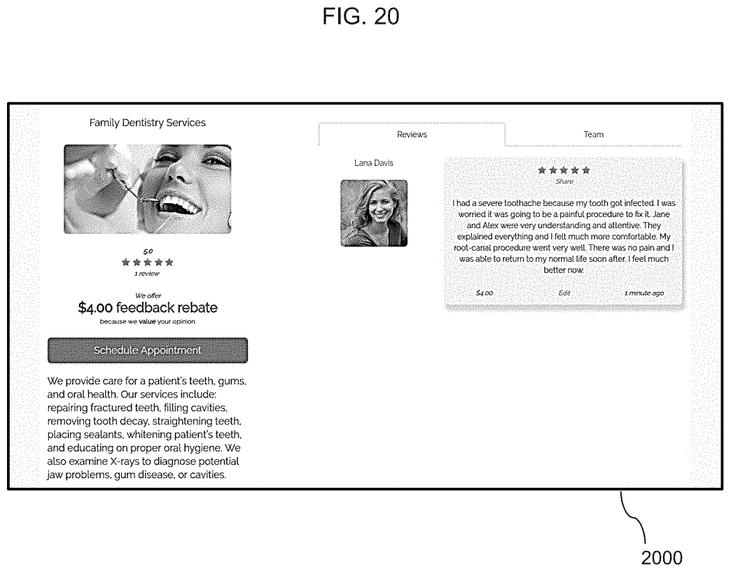

In a related embodiment, the reputation network system 100 can include a scenario with a feedback rebate, which is a particular type of rebate that customers can redeem by leaving honest feedback (e.g. a review), such that the scenario can include:
a) Listing owner 180 posts a product listing (using a listing GUI 900 as shown in FIG. 9) of his product which includes product information and a feedback rebate offer; and sends an invitation 700 (shown in FIG. 7) to an employee who contributed to this product, the contributor;
b) The contributor 180 accepts the invitation by adding a contribution record including contribution information, including her role and contribution (using a role GUI 800 as shown in FIG. 8). A snippet of this contribution record, containing her name, role, and contribution, is displayed on her profile page 1000, as shown in FIG. 10, and at the same time displayed on the product listing page 900 (FIG. 9) with a link back to her profile;
c) The consumer sees the feedback rebate offer, buys the product, and later redeems their feedback rebate by leaving a product review and contributor feedback (on review GUI 1100 as shown in FIG. 11), such that the consumer user redeems the feedback rebate offer and receives a corresponding feedback rebate after providing the product review. The product review may be positive or negative. For this example, we will assume the review is positive. A snippet of customer's review record, comprising her name, rating, and comment, is displayed on her customer profile page 1900 (as shown in FIG. 19) and at the same time displayed on the product listing page 2000 (as shown in FIG. 20) with a link back to her profile;
d) The contributor receives a notification of customer feedback received. Her reputation rank, compared to the reputation ranks of other contributors who make similar contributions to similar products, improves incrementally due to the positive feedback left by the customer. The second consumer searches the network for a product like the one mentioned above. The network system uses product reputation rank algorithm, described later in this disclosure, to suggest specific product listings. This product reputation rank depends at least in part on the aggregated customer feedback each product had received in the past; and
e) An employer searches the network for a contributor like the one mentioned above. The network system uses a contributor reputation rank algorithm, to suggest specific users and their contributions. This rank depends at least in part on the aggregated customer feedback received for products to which the contributor contributed in the past.

Thus, given the examples above, the reputation network system 100, including its role contribution and feedback rebate methods, enabled each actor to achieve his or her goals, including:
a) The listing owner was able to encourage (incentivize) a sale, receive customer feedback, and allow his employee to take ownership of that feedback;
b) The contributor was able to take ownership of her contribution, receive direct customer feedback, and improve her professional reputation rank (alternatively, negative feedback would result in an incrementally worse reputation rank);
c) Both consumers, whose goal was to find and purchase the best product for the best price, were aided by reputation rank algorithm to find such product. A feedback rebate offer served as both an assurance of product's quality and a sale incentive. The product's reputation rank, based in part on the aggregated consumer feedback, served as an additional assurance of quality; and
d) The employer, whose goal was to obtain a more objective measure of a potential employee's past performance (i.e., reputation), could do so because of the link between each potential employee's contribution and their products' performance in the marketplace, as judged in part by the consumer feedback.

In related embodiments, the reputation of products and their contributors can be assessed not only algorithmically but also by visually scanning the products and their reviews. The reputation rank can also be assessed by factors, such as the number of products sold, the number of repeat customers, the number of subscribers (i.e., “followers”), and the type of individual review comments consumers have left, to give just a few examples. The role title, the description of the contribution and various product and content tags can be used to filter possible results further and guide the searcher (e.g., employer) to find and rank individual contributors. Hence, the concept of a “reputation” rank refers not only to the algorithmically calculated value generated by the reputation network system 100 but also to other objective criteria and subjective judgments that are enabled by the reputation network system 100.

The figures provided with this disclosure depict various embodiments of the invention for purposes of illustration only. One skilled in the art will readily recognize from the following discussion that alternative embodiments of the structures and methods illustrated herein may be employed without departing from the principles of the invention.

FIG. 1 is a network diagram depicting a client-server reputation network system 100 that includes various functional components of a reputation network server 120 in accordance with some implementations. The reputation network system 100 can include one or more reputation network devices 102, a reputation network server 120, and one or more other external platforms 150. One or more communications networks 110 interconnect these components. Hence, the reputation networking server 120 provides a platform, or backbone, which other systems, such as reputation network devices 102, may use to provide reputation networking services and functionalities to users across the Internet.

In one embodiment, the communication network 110 uses standard communications technologies and/or protocols. Thus, the network 110 can include links using technologies such as Ethernet, 802.11, worldwide interoperability for microwave access (WiMAX), 3G, 4G, CDMA, GSM, LTE, digital subscriber line (DSL), etc. Similarly, the networking protocols used on the communication network 110 can include multiprotocol label switching (MPLS), transmission control protocol/Internet protocol (TCP/IP), User Datagram Protocol (UDP), hypertext transport protocol (HTTP), simple mail transfer protocol (SMTP), and file transfer protocol (FTP). The data exchanged over the network 110 can be represented using technologies and/or formats including hypertext markup language (HTML), JSON, and extensible markup language (XML). In addition, all or some links can be encrypted using conventional encryption technologies such as secure sockets layer (SSL), transport layer security (TLS), and Internet Protocol security (IPsec).

The reputation network device 102 comprises one or more computing devices that can receive input from a user and can transmit and receive data via the network 110. In one embodiment, the reputation network device 102 can be a conventional computer system executing, for example, a Microsoft Windows compatible operating system (OS), Apple OS X, and/or a Linux distribution. In another embodiment, the reputation network device 102 can be a device having computer functionality, such as a smart-phone, a tablet, a personal digital assistant (PDA), a mobile telephone, etc. The reputation network device 102 can be configured to communicate via the network 110. The reputation network device 102 can execute an application 104, for example, a browser application 106 that allows a user of the reputation network device 102 to interact with the reputation network server 120. The reputation network device 102 can be configured to communicate with the reputation network server 120 via the network 110, which may comprise any combination of local area and/or wide area networks, using wired and/or wireless communication systems.

In some embodiments, the reputation network device 102 sends a request to the reputation network server 120 for a webpage associated with the reputation network system 100 (e.g., the reputation network device 102 sends a request to the reputation network server 120 for an updated product listing webpage). For example, a user 180 of the reputation network device 102 logs onto the reputation network server 120 and clicks to view their profile page. In response, the reputation network device 102 receives the user's updated profile page (e.g., new consumer reviews, changes in reputation rank, new subscribers) and displays them on the reputation network device 102.

In a presently preferred embodiment, as shown in FIG. 1, the reputation network server 120 is generally based on a three-tiered architecture, consisting of a front-end layer 121, application logic layer 123, and data layer 125. Each module in FIG. 1 represents a set of executable software that sends instructions to the corresponding hardware (e.g., processor and memory). Skilled artisans in computer and web-technologies will recognize this architecture and understand that various additional components may be used with a reputation network server 120 to facilitate additional functionality that is not specifically described herein. To avoid unnecessary detail, various functional modules and engines that are not germane to conveying an understanding of the various implementations have been omitted from FIG. 1.

As shown in FIG. 1, the front-end layer 121 can include a user interface module 122 (e.g., a web server), which receives requests from various reputation network devices 102 or external systems 150 and communicates appropriate responses to the requesting reputation network devices 102 or external systems 150. For example, the user interface module(s) 122 may receive requests in the form of Hypertext Transport Protocol (HTTP) requests, or other web-based, application programming interface (API) requests. The reputation network device 102 may be executing conventional web browser applications or applications that have been developed for a specific platform to include any of a wide variety of mobile devices and operating systems.

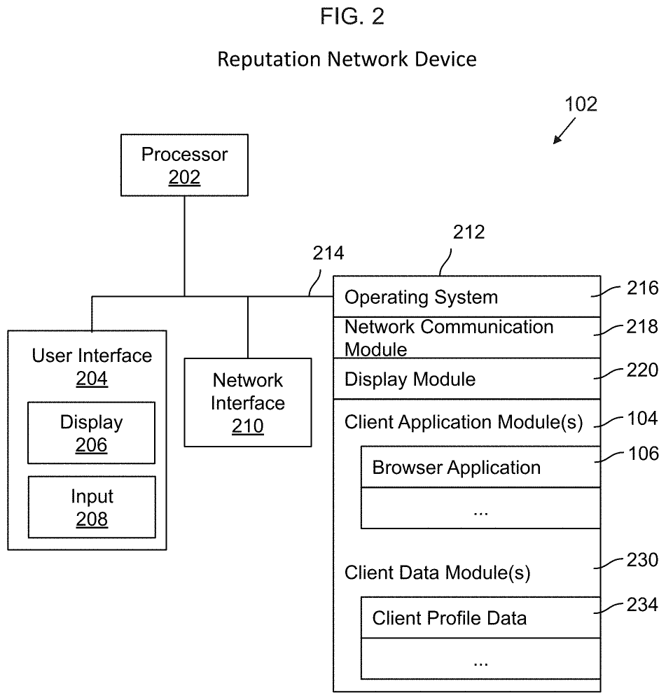

FIG. 2 is a block diagram illustrating a reputation network device 102 in accordance with some implementations. The reputation network device 102 typically includes one or more processing units (CPU's) 202, one or more network interfaces 210, non-transitive memory 212, and one or more communication buses 214 for interconnecting these components. The reputation network device 102 can include a user interface 204, or in general an input/output component 204. The input/output 204, including the user interface 204 includes a display device 206 and optionally includes an input means such as a keyboard, mouse, a touch sensitive display, or other input buttons 208. Furthermore, some reputation network devices 102 use a microphone and voice recognition to supplement or replace the keyboard.

In related embodiments, non-transitive memory 212 includes high-speed random access memory, such as dynamic random-access memory (DRAM), static random access memory (SRAM), double data rate random access memory (DDR RAM) or other random access solid state memory devices; and may include non-volatile memory, such as one or more magnetic disk storage devices, optical disk storage devices, flash memory devices, or other non-volatile solid state storage devices. Memory 212 may optionally include one or more storage devices remotely located from the CPU(s) 202. Memory 212, or alternatively, the non-volatile memory device(s) within memory 212, comprise(s) a non-transitory computer readable storage medium.

In some embodiments, memory 212 or the computer readable storage medium of memory 212 can store programs, modules and data structures, including all or a subset of:
a) a network communication module 218 that can be used for connecting the reputation network device 102 to other computers via the one or more communication network interfaces 210 (wired or wireless) and one or more communication networks, such as the Internet, other wide area networks, local area networks, metropolitan area networks, etc.;
b) a display module 220 for enabling the information generated by the operating system 216 and client applications 104 to be presented visually on the display 206;
c) at least one reputation network device 102 for enabling user 180 interaction with the reputation network server 120, the reputation network device 102 including:
   i. a browser application 106 for requesting information from the reputation network server 120 (e.g., product listing pages and user information) and receiving responses from the reputation network server 120; and
   ii. a client data module 230, for storing data relevant to the clients, including:
      1. client profile data 234 for storing profile and account data related to a user of the reputation network system 100, accessing via the reputation network device 102.

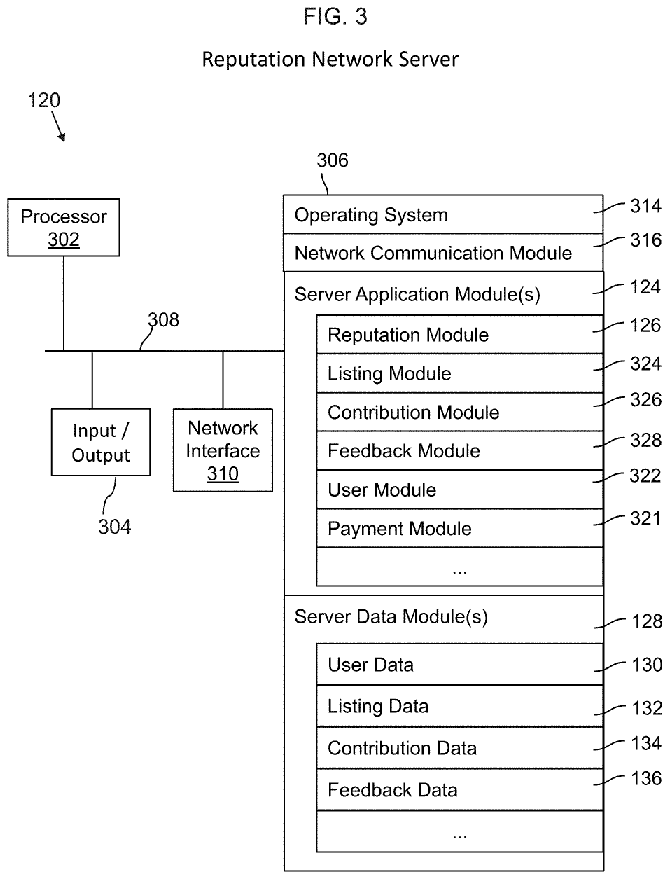

FIG. 3 is a block diagram illustrating a reputation network server 120, in accordance with some embodiments. The reputation network server 120 typically includes one or more processing units (CPU's) 302, one or more network interfaces 310, memory 306, and one or more communication buses 308 for interconnecting these components. Memory 306 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. Memory 306 may optionally include one or more storage devices remotely located from the CPU(s) 302. Memory 306, or alternately the non-volatile memory device(s) within memory 306, comprises a non-transitory computer readable storage medium. In some embodiments, memory 306 or the computer readable storage medium of memory 306 can store the following programs, modules and data structures, or a subset thereof:
a) an operating system 314 that includes procedures for handling various basic system services and for performing hardware dependent tasks;
b) a network communication module 316 that is used for connecting the reputation network server 120 to other computers via the one or more communication network interfaces 310 (wired or wireless) and one or more communication networks, such as the Internet, other wide area networks, local area networks, metropolitan area networks, etc.;
c) at least one application module 124 for performing the services offered by the reputation network server 120, including but not limited to:
   i. a reputation module 126 for calculating and updating various relative reputation ranks and values based at least in part on consumer feedback (relative reputation ranks maintained by the reputation module 126 enable users of the reputation network server 120 to easily order, sort, filter, search, and compare customers, products and contributors using quantified reputation information about them);
   ii. a user module 322 for allowing a new member to join the reputation network system 100 (e.g., providing a sign-up web page), update and verify profile and account information (e.g., updating email, phone, name, profile image), view profiles (e.g., providing user's profile page), delete and restore member accounts;
   iii. a listing module 324 for allowing users to create listings of their products and services on the reputation network server 120 (e.g., providing a web-form to collect and save product information, such as the product title, price, feedback rebate settings, and product image), update and verify listing information (e.g., providing web-form to update product information), view listings (e.g., providing product listing page, providing product listing snippets as search results), delete and restore listings;
   iv. a contribution module 326 for allowing contributing users (contributors) to join listings and provide their roles and contributions on the reputation network system 100, update and verify contribution information (e.g., updating role, contribution timeframe, contribution description), view contributions (e.g., providing contribution page, providing contribution snippets on the listing page, providing contribution snippets on user's profile page), delete and restore contribution records;
   v. a feedback module 328 for allowing consuming users (i.e., consumers, customers) to share their feedback on the reputation network system 100 (e.g., providing a review web-form), update and verify feedback-related information (e.g., verifying order information, providing a unique claim url, providing a web-form to edit feedback), view feedback (e.g., providing a review page, providing review snippets on the listing page, providing review snippets on user's profile page), delete and restore feedback records;
   vi. a payment module 321 for facilitating sale and refund transactions between users on the reputation network server 120 and external systems 150 (e.g., receiving a refund after a review submission);
d) a server data module 128, holding data related to the reputation network server 120, including:
   i. user data 130 including data representing users of a reputation network server 120, such as email, phone number, account balance, history of transactions, activity history, encrypted password, name, profile image, external references (e.g., external id(s) referencing a user record of the same individual on external system(s) 150 integrated with the reputation network server 120), and so on;
   ii. listing data 132 including data representing products and services listed on a reputation network server 120, such as product title, description, price, feedback rebate, average customer satisfaction rating, number of reviews, relative reputation rank, number of contributors, average contributor reputation rating, relative contributor reputation rating, location, created date, last updated date, contact information (e.g., business phone number) history of updates (e.g., information about when the update was made, which fields were updated, previous values of those fields, the user who made the update), external references (e.g., external id(s) referencing the same product on external system(s) 150 integrated with the reputation network server 120), and so on;
   iii. contribution data 134, including data representing contribution of a user to product(s) or service(s), such as role, contribution description, contributor's email, invitation status (e.g. accepted, pending, declined) reference to the contributor's user record (e.g., user id), reference to the listing record (e.g., listing id), created date, last updated date, start contribution date, end contribution date, number of reviews (e.g., total number of reviews from consumers of all contributor's products), average reputation rank, relative reputation rank, number of parent listings, number of collaborator reviews (e.g., feedback from collaborators), average collaborator reputation rank, relative collaborator reputation rank, history of updates, and so on;
   iv. feedback data 136, including data representing feedback of a consumer, such as a satisfaction rating, comment, purchase date, created date, last updated date, reference to the consumer's user record (e.g., user id), order information (e.g., JSON object representing order data stored in a field on the feedback record), feedback rebate value, rebate “available at” date, rebate “expires at” date, status (e.g., pending, available, submitted, expired), reference to the product listing record (e.g., listing id), quantity purchased, weight of feedback (value calculated by the reputation module 126 taking into account, among other things, the quantity purchased, frequency of purchases, and user's reputation rank value as a customer), unique claim url, origin (e.g., created using web-form, created via external system's API 152), net promoter score (NPS), other satisfaction ratings and comments set up by the listing owner in the listing's feedback rebate settings, and so on.

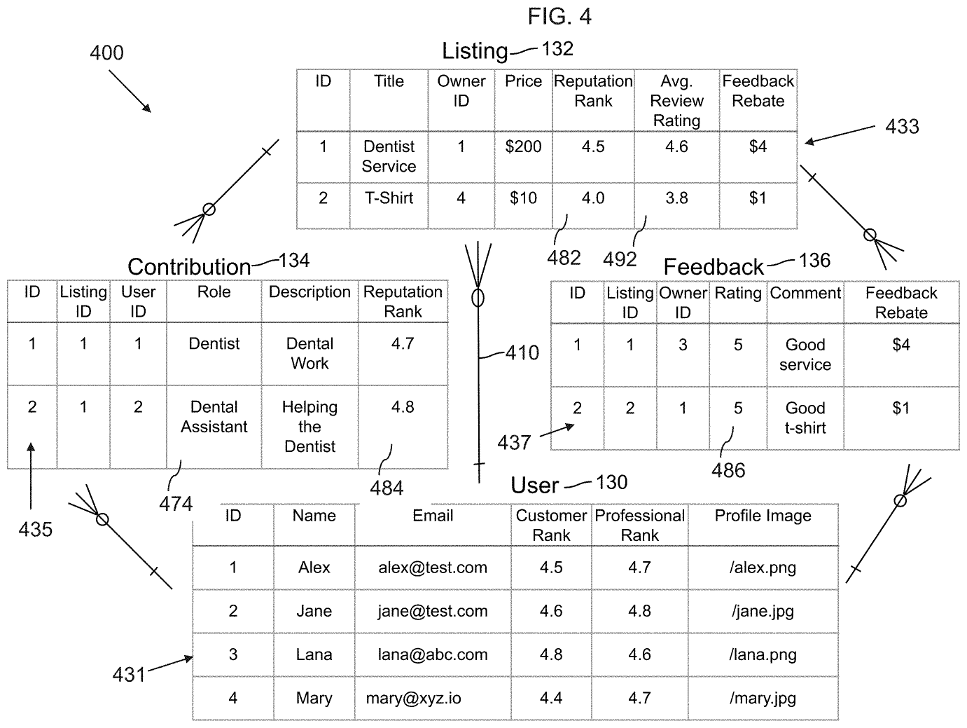

In a related embodiment, FIG. 4 shows an Entity Relationship Diagram (ERD) illustrating the architecture of database objects and their relationships. This diagram represents the data layer 125 architecture.

As shown in FIG. 4, the data layer 125 can include a database storing data about several entities, including user data 130 (e.g., user's contact information, activity history, location, type of communication device used), contribution 134 (e.g., data that describes the contribution and the relationship of a particular user to a particular product listing, including various tags and reputation ranks), feedback data 136 (e.g., data that describes a consumer interaction and feedback in regard to a particular listing, including feedback specific to certain features and/or contributors), listing data 132 (e.g., data that describes products, services, events, businesses, and other manifestations of value and their feedback rebate offers). Of course, in various alternative implementations, any number of other entities may be included, or the current entities may be broken down into separate ones (e.g., using separate entities to store data about products and services), and as such, various other database schemas may be used to store data corresponding with other entities without departing from the principles of the invention as understood by persons skilled in the art.

Other components, such as network interfaces, security mechanisms, load balancers, failover servers, management, and network operations consoles, and the like; as well as functions, such as registration, authentication, and authorization, are not shown so as to not obscure the details of the system. A person skilled in the art will be able to use prior art to implement these additional components and functions.

In a related embodiment, as shown in FIG. 4, relationships of records can be implemented using relational database technology, including a reference field on related records. For example, a Listing record can include an “owner id” field, which references a specific User record and designates that user as the owner of the listing. The same reference field can be used as part of an SQL (structured query language) query by the reputation network server 120 to find and provide listings “owned” by a specific user. This type of relationship is illustrated by a crow-foot arrow 410 representing a one-to-many relationship and its direction between two objects. In the example above, one might describe the relationship as a user “has many” listings and a listing “belongs to” a user. “Has many” is optional, as indicated by the circle in the crow-foot arrow 410 pointing from user object towards the listing object (i.e., a particular User may or may not “have many” listings). On the other side of the relationship, according to the present embodiment, every listing must “belong to” one user as indicated by the short line crossing the crow-foot arrow 410 pointing from the listing object towards the User object. Relationships between other objects will be described using this nomenclature.

In related embodiments, a listing owner is a reference to an individual User who is related by reference (e.g., “owner id”) to a particular Listing. In the present embodiment, the listing owner reference also defines the authorization scope of the User. In other implementations, however, such authorization can be obtained or assigned to different users depending on the use case and company policies. For example, all users who work for a specific company and have a title of manager may be authorized to create and edit any Listing record related to the same company. For the sake of simplicity, when alluding to the authorization aspect of the relationship between User and Listing records, Listing Owner should be viewed as the User with the broadest authorization scope towards his Listings.

For the following process descriptions, assume that each user is a registered member of the reputation network system 100 authorized to perform the described action.

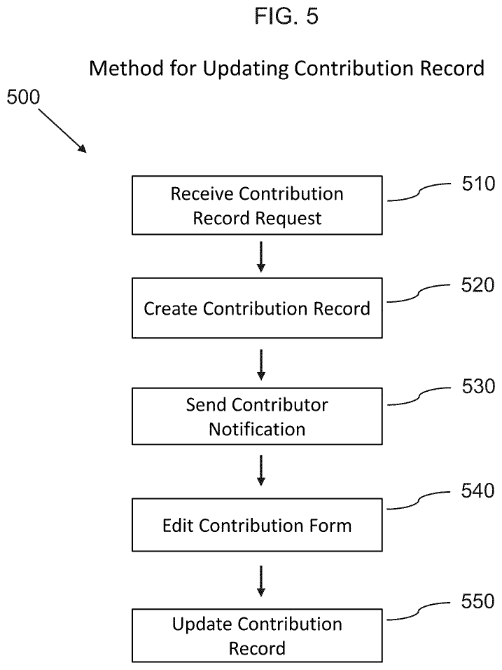

In a related embodiment, FIG. 5 shows a diagram of a method for updating a contribution record 500, wherein a contributing user (i.e., “contributor”) is associated with the listing record via the contribution record; wherein the method for updating a contribution record 500 includes:
a) Receiving a contribution record request 510, wherein the reputation network server 120 receives a request to create a contribution record under (i.e., belongs to) a specific product listing record.

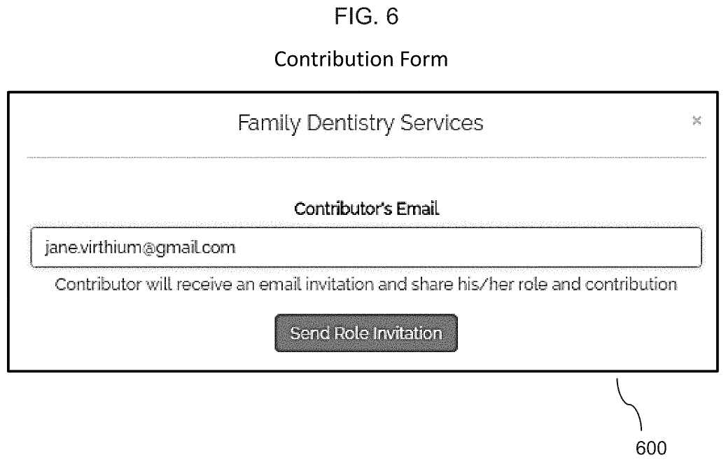

In the present implementation, the graphical user interface 122 (GUI) (as shown in FIG. 1), generated by the contribution module 326, includes the new contribution form 600 (as shown in FIG. 6). As illustrated in FIG. 6, this form can be implemented as an invitation from a listing owner to a contributor. In such implementation, the listing owner can use the new contribution form 600 to enter contributor's email and send the invitation to the contributor. The invitation would contain a link to the edit contribution form 800 (as shown in FIG. 8).

The contribution module 326 method that generates the new contribution form 600 also adds a hidden listing reference field value equal to the current listing's ID, so that when the reputation network server 120 receives the HTTP request (e.g., POST, PUT, PATCH) via the form submission from the user's communication device, the new contribution record can automatically belong to the Listing record.

In other embodiments, this request can be generated by other members of the reputation network, including consumers and the contributors themselves. The new contribution form 600 may include other fields, such as role title, contribution description, or timeframe of contribution, depending on the implementation. An external system 150 (as shown in FIG. 1), such as a properly authenticated and authorized third-party application, can use the services provided by the reputation network server 120 user interface 122 (e.g., Application Program Interface (API)) to process a method for updating a contribution record 500, as shown in FIG. 5, which can include:
a) Receiving a contribution record request 510;
b) Creating a contribution record 520, wherein the reputation network server 120 creates a contribution record. Before saving the contribution record in the database, the reputation module 126 calculates the relative reputation rank (as described further below) and assigns the relative reputation rank value to the corresponding rank field on the contribution record. Later, this value can be shown to users and used to provide, order, filter, and compare search results. This value will also be periodically recalculated and updated by the reputation module 126 to reflect the most up-to-date relative reputation;
c) Sending contributor notification 530, wherein the contributor module 326 (as shown in FIG. 8) sends an invitation notification to the contributor with a link (e.g., “Accept Invitation” button) to the contribution edit form 800 (as shown in FIG. 8);
d) Editing contribution form 540, wherein the contribution module 326 can provide the contribution edit form 800 to the contributor with additional fields, such as the role title and the contribution description, to be filled out and submitted by the contributor. The contribution module 326 method that generates the edit contribution form 800 also can add a hidden user reference field value equal to the contributor's user ID, such that when the reputation network server 120 receives the HTTP request (e.g., POST, PUT, PATCH) via the form submission from the user's communication device 102, the edited Contribution record can automatically belong to the contributor's User record; and
e) Updating contribution record 550, wherein the reputation network server 120 updates the contribution record with the new information submitted by the contributor via the edit contribution form 800. The data from this contribution record can now be displayed on the product listing page 900 (as shown in FIG. 9), search results, contributor's profile page 1000 (as shown in FIG. 10), and external websites via API.

In a related embodiment, FIG. 6 shows an example of a “new contribution form” provided to the user by the contribution module 326 via the Graphical User Interface (GUI) 122. The form can be used by the listing owner to create a contribution record and send an invitation to the contributor.

In another related embodiment, FIG. 7 shows an example of an email invitation sent by a listing owner to a contributor providing the contributor with a unique link (e.g., “Accept Invitation” button) to accept this invitation and provide additional data (e.g., using the edit contribution form 800).

In yet another related embodiment, FIG. 8 shows an example of an “edit contribution form” provided to the contributor by the contribution module 326 via the Graphical User Interface (GUI) 122. The form can be used by the contributor to accept the invitation and provide additional contribution data, such as a role and a description.

In another related embodiment, FIG. 9 shows an example of a product listing page 900 displaying the product information, feedback rebate offer, and snippets of contribution records that belong to the listing. This page can be generated by the listing module 324 (as shown in FIG. 3) and displayed via the Graphical User Interface (GUI) 122.

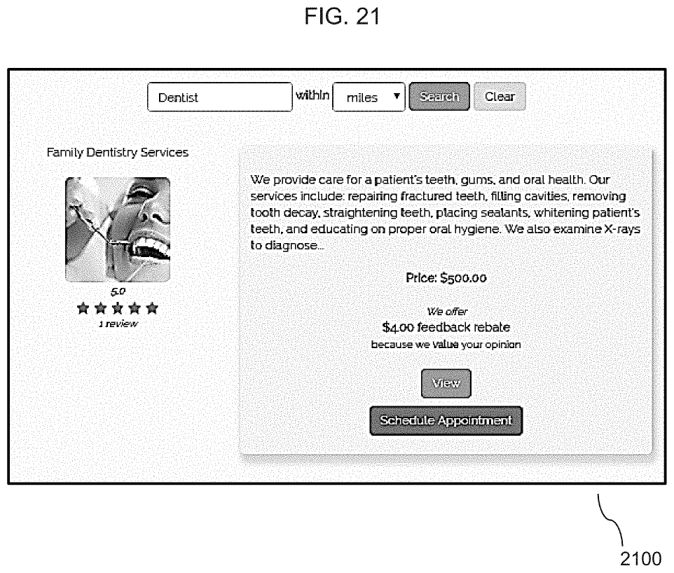

In another related embodiment, FIG. 21 shows an alternative example of a product/service listing page 2100.

In a related embodiment, FIG. 10 shows an example of a user's professional profile page displaying information about the user (e.g., name, profile image) and her contributions (e.g., role, contribution, product information, product's average review rating). This page is generated by the user module 322 (as shown in FIG. 3) and displayed via the Graphical User Interface (GUI) 122.

In another related embodiment, FIG. 11 shows an example of a review form provided to the consumer by the feedback module 328 via the GUI 122. The review form can be used by the consumer to leave a review and receive the promised feedback rebate.

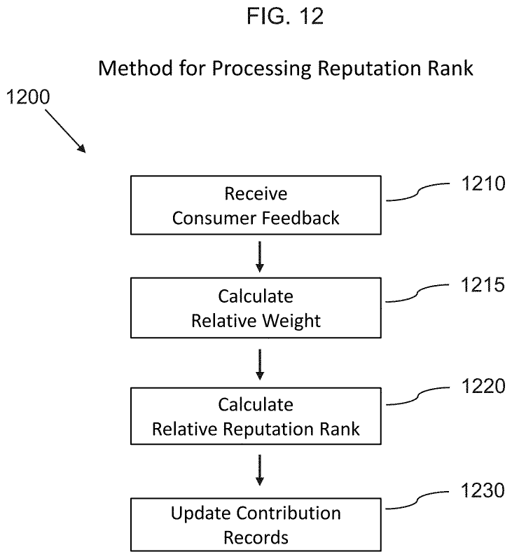

In an embodiment, FIG. 12 shows a method for processing reputation rank 1200 for calculating, setting and updating reputation rank of contribution records, wherein the method for processing reputation rank 1200 can include:
a) Receiving consumer feedback 1210, wherein the reputation network server 120 receives a request to create or update a consumer feedback record, such as a product review that belongs to a specific product listing record, wherein:
   i. the request is received when the consumer submits the review form 1100 containing data such as the rating and the comment. The feedback module 328 method that generates the review form 1100 also adds a hidden listing reference field value equal to the current Listing's ID and a hidden user reference field value equal to the current user's ID, such that when the reputation network server 120 receives the appropriate HTTP request (e.g., POST, PUT, PATCH) via the form submission from the user's communication device, the feedback record can be automatically related to (i.e. belong to) the listing record and the consumer's User record; and
   ii. any process for generating or importing consumer feedback (e.g., reviews) within the reputation network server 120 may be used; and can include the feedback rebate method (described in further detail below). In other related embodiments, this request can be generated by a user uploading a file containing review data in CSV, JSON, XML, or some other computer-readable format. Depending on the implementation, the review form 1100 may include additional fields, such as satisfaction ratings for specific product functions, comments on specific product features, and Net Promoter Score (NPS). An external system 150 (as shown in FIG. 1), such as properly authenticated and authorized a third-party application, can use the provided by the reputation network server 120 user interface 122 (e.g., Application Program Interface (API)) to send requests to create and update feedback records.

In a related embodiment, the method for processing reputation rank 1200 can further include calculating relative weight 1215, wherein after the feedback record has been successfully saved, the reputation module 126 automatically calculates and updates the relative weight of the feedback, wherein:
a) The relative weight of the feedback, in its simplest form, can be calculated using the quantity of the product purchased. For example, a consumer review left as a result of purchasing two products weighs twice more (e.g., 2) than the review that was left as a result of purchasing a single product (e.g., 1). Therefore, a weight of the reviews can be used when calculating the total number of reviews in reputation rank calculations (e.g., 1×2+1=3), instead of the actual number of reviews (e.g., 1+1=2); and
b) More complex formulas to determine the relative review weight can be implemented using the data collected through the reputation network server 120 and stored in its server data modules 128 (as shown in FIG. 1). For example, the reviewer reputation as a customer, determined in part by the aggregate feedback from other users on the quality of the feedback, as well as the frequency of purchases and the total amount of money spent on the product, may be incorporated into the review weights and the reputation rank formulas. As the related data is consistently captured and analyzed, reputation formulas can change and improve in the future.

In a related embodiment, the method for processing reputation rank 1200 can further include calculating relative reputation rank 1220, wherein after the feedback record has been successfully saved and the relative weight has been updated, the reputation module 126 automatically calculates and updates the reputation rank of the product listing, wherein:
a) The listing reputation rank can be calculated using a weighted average formula, such that:
   i.

Listing Reputation Rank (LRR)=(v/(v+m))×R+(m/(v+m))×C
where: R=average rating of the listing
   v=number of reviews (votes) for the listing (measured by weight)
   m=amount of votes required to reach statistical significance (measured by weight)
   C=the mean review rating across the data set of similar listings; and
ii. Wherein, each time a new review is saved or an existing review is updated, the related listing's reputation rank is updated in accordance with a formula like the one above. Periodically, each listing's reputation rank is updated even if it didn't receive a review to maintain the accuracy of the relative reputation rank across all listing records.

In a related embodiment, the method for processing reputation rank 1200 can further include updating contribution record 1230, wherein after the feedback record had been successfully saved and the listing reputation rank updated, the reputation module 126 automatically updates the reputation rank of each contribution record that belongs to the reviewed listing; wherein:
a) The contribution reputation rank can be updated periodically, as well as after a new review is saved, or an existing review is updated under the related listing record. The same formula used to calculate the product reputation rank can be used as a base for calculating the contribution reputation rank, such that:
   i.

Contribution Reputation Rank (CRR)=(v/(v+m))×R+(m/(v+m))×C
where: R=average rating for the listing(s) to which the contribution record belongs to;
v=number of reviews (measured by weight) for the listing(s) to which the contribution record belongs to
   m=amount of votes required to reach statistical significance (measured by weight) C=the mean review rating across the data set of similar contributions. The similarity can be determined by methods described below.

In related embodiments, a plurality of different implementations of the feedback weight and the reputation rank formulas can be used. The ones presented above are examples that would be hard or impossible to implement effectively outside the reputation network system 100. The specific database and entity-relationship architecture in conjunction with the processes for gathering and processing the data described herein as part of the invention create this possibility of providing a more objective metrics of reputation. The contribution reputation rank (CRR) is one example of such a metric enabled by this invention.

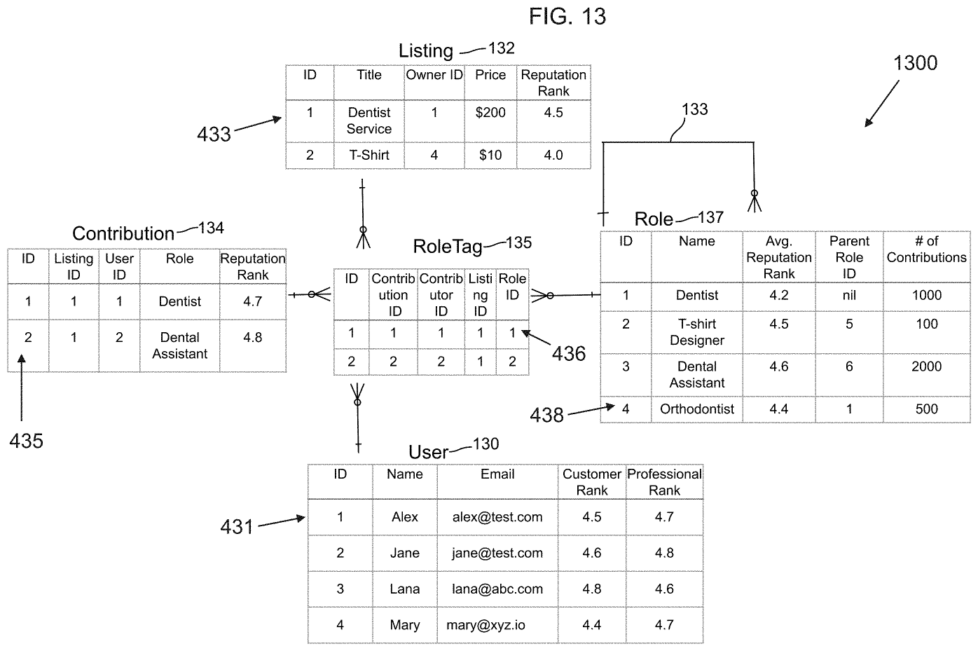

In another related embodiment, as shown in FIG. 13, the reputation network system 100 can further include a role object 137 and a joint role tag object 135. The role object 137 can be a database table that stores role records. Each role record can belong to multiple contribution records, multiple listings, and multiple contributors through the joint role tag object 135. A primary purpose of the role object 137 is to provide one aggregate reputation rank for a specific type of a job or a role. One way to look at it is as an abstraction of the role field on the Contribution object 134 into its own object. The introduction of the Role is not necessary for the basic implementation of this invention because the individual contribution records already include the role and the relative reputation rank fields. However, the abstraction of the Role into an object can add additional filtering, grouping, ordering, and sorting capabilities that can be very useful for providing relative reputation metrics.

In a further related embodiment, the role object 137 can also be related to itself (i.e., having both “belong to” and “have many” relationships) in one-to-many relationship 133, which provides an ability for the reputation network server 120 to build hierarchies of Role records. For example, an orthodontist's contribution can be ranked in both “orthodontist” and “dentist” categories (i.e., roles). One is simply a subcategory of another. Therefore, it would be beneficial if each contribution record could be assigned to multiple and ever more specific roles so that the reputation rank could be appropriately attributed to the desired level of the contributor's work specialization.

In a related embodiment, the additional filtering, grouping, ordering, and sorting capabilities requires a many-to-many relationship between the contribution 134 and the role 137 objects, which can be achieved by a role tag 135 as a joint object. The role tag object 135 can be implemented with a one-to-many relationship to both the contribution object 134 and the role object 137, effectively creating a many-to-many relationship between them. Alternative architectures of relationships between database objects can, of course, be implemented to achieve a similar goal.

In a further related embodiment, the role tag object 135, can also be used as a joint object to enable a many-to-many relationship between contribution 134 and listing 132, which will enable additional grouping, filtering, and sorting capabilities between these two objects. In the basic database architecture implementation shown in FIG. 4, without the role 137 and the role tag 135 objects, the relationship between contribution 134 and listing 132 is one-to-many, meaning one contribution record can only reference (i.e., belong to) one Listing record at any time, while one Listing record can be referenced in many (i.e., have many) contribution records. The many-to-many relationship between these two objects, enabled through the joint role tag object 135, makes it possible for one contribution record to have many listings and vice versa. Such a relationship can be useful in situations when a single user made the same contribution to multiple listings. For example, an orthodontist can make the same contribution working for different companies over a number of years. In such case, the user can select an existing contribution record and add it to the new listing every time they switch companies without the need to duplicate the same data for each listing.

In a related embodiment, any process for capturing the necessary data to create many-to-many relationships may be used. In the present implementation, when a contributor is entering data into the role title field, with every letter entered, the page runs a JavaScript code that automatically searches the database for similar Role records and displays the selectable list of found Role records to the contributor. When the contributor saves the contribution record, for each selected Role record a role Tag record is also created. Each role tag record automatically includes the necessary references (e.g., IDs) to the role, the contribution record's listing, and the contributor's user record, as illustrated in FIG. 13.

In another related embodiment, the architecture shown in FIG. 13 is designed, to enable ranking of each contribution record relatively to similar contribution records. In the original implementation FIG. 4, such similarity is determined algorithmically by the reputation network server 120 using the role title and the description text field values from contribution records. Although such comparison is possible without the role 137 and role tag 135 objects, introducing these objects and their relationships allows the reputation network server 120 to abstract the similarities among contribution records and make these similarities more explicit and reliable.

For example, the architecture shown in FIG. 13 enables a user to select a role and find every contribution record related to that role through the joint role tag records, and then compare each found contribution record by its reputation rank. Moreover, the contribution records could be compared at different levels of the role hierarchy. For example, an individual contribution record could be ranked first under the “orthodontist” role and tenth under the “dentist” role, given that each of these two roles are related to one another via a one-to-many relationship, such as a more specific “orthodontist” role would include a reference (e.g., parent id) to the “dentist” role.

In a related embodiment, the reputation network system 100 can be configured to process consumer feedback (i.e., customer reviews). The quality of the feedback and the process of gathering it are very important for the reputation network system 100 to function optimally. Thus, the wrong kind of consumer feedback can damage the function of a reputation network.

In order to be effective, the consumer feedback must be gathered in a particular way and follow certain specifications. The feedback must be reliable, plentiful, trustworthy, and affordable. Particularly since the feedback affects people's personal reputation, not just the product's or company's reputation. The existing solutions for gathering consumer feedback fail in at least one of these specifications, so a new, more effective and efficient method, was created to work best within the reputation network system 100.

In a related embodiment, the reputation network server 120 can be configured to process a feedback rebate mechanism. The feedback rebate can be a conditional sale incentive (i.e., it is offered to potential customers before the sale to increase sales) that can be redeemed by leaving honest feedback (e.g., positive or negative review).

In a further related embodiment, similar to any discount, the feedback rebate can be a sale incentive that is entirely reciprocated by the customer's act of purchasing the product. After the sale, the customer is entitled to a partial refund if they review the product or service within a specified period. Because the merchant's “favor” was fully reciprocated by the customer at the time of purchase, the resulting review is not biased. In other words, the feedback rebate is a sale incentive, not a review incentive.

In a related embodiment, the reputation network server 120 acts as an impartial intermediary, not unlike a bank. By way of an analogy, after the sale, a feedback rebate is similar to a check that was issued by the reputation network system 120, filled out and signed by the merchant, and can be cashed by the customer using the reputation network server 120. The system 120 uses various encryption and verification techniques to generate feedback rebates and confirm the authenticity of each feedback rebate claim.

Although the feedback rebate method could work, to a certain extent, outside the reputation network server 120 and its various implementations, such use would be less optimal. For example, if a feedback rebate is redeemed and the review is left on a network without a properly enforced one-user-one-account policy, or without authentication at all, or the review is not linked to the reviewer's professional profile, the reviewer may not take personal responsibility for the quality of their feedback, which may render the feedback less reliable and less trustworthy. In another example, without a properly designed reputation network acting as a trusted intermediary, businesses may not offer previously dissatisfied consumers a feedback rebate for their next purchase. In turn, consumers may fear retaliation from businesses for negative feedback and provide more favorable (i.e., biased) feedback than the product deserves.

The term “feedback rebate” in this disclosure will refer to the conditional sale incentive represented by the stored data about its conditions. There are two sets of data representing feedback rebate conditions: the offer settings and the instance of the offer. For example, a feedback rebate offer on a particular listing is a currently active $5 rebate that will become available to redeem seven days after the purchase and expire in three days after that, unless redeemed by a customer. These conditions constitute an offer and can be changed at any time by the listing owner. The conditions data about the offer (i.e. “offer settings”), according to the present implementation, is stored on the listing record in fields, such as “rebate amount,” “rebates available in,” and “rebates expire in,” for example. Before the purchase, a “feedback rebate” can be thought of as a special offer (i.e., sale incentive) for purchasing the product.

Once the product is purchased, an instance of the feedback rebate is created and its current conditions stored on the feedback record, in fields, such as “rebate,” “available_at,” and “expires_at,” for example. These values can be calculated based on the current feedback rebate offer settings on the related listing. A detailed example of this calculation will be illustrated later in this disclosure. After the sale, the customer is entitled to a partial refund (i.e., rebate) if the conditions are satisfied. These conditions constitute an instance of the offer and won't change, even if the listing owner changes the offer conditions on the listing record. After the purchase, a “feedback rebate” can be thought of as a signed check for a specific amount that needs to be cashed during a certain timeframe.

Whether the “feedback rebate” refers to the offer or the instance is sometimes not pertinent to the understanding of the subject matter, or it's easy to determine from the context. This distinction will be made explicit in cases where it is important and not obvious.

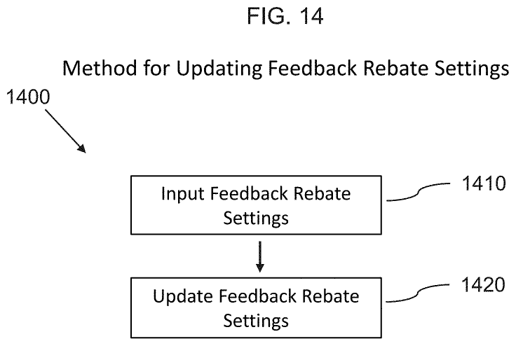

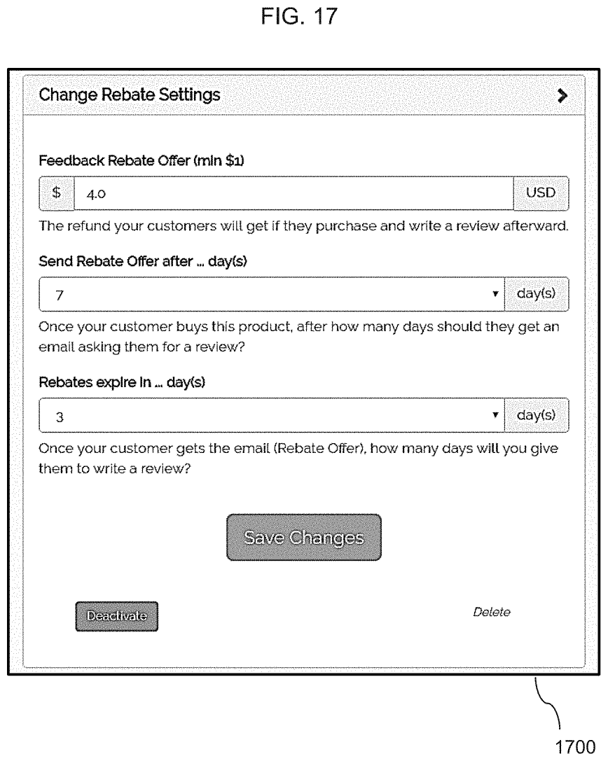

In a related embodiment, FIG. 14 shows a method 1400 for updating feedback rebate settings for a product listing, wherein the method includes:
a) Inputting feedback rebate settings 1410, wherein the reputation network servers's 120 user interface 122 provides a web-form, an API, or another type of interface for a user or an external system to provide feedback rebate settings data for a listing. An example of a web-form interface is illustrated in FIG. 17. In the present implementation, the feedback rebate settings data comprises the rebate amount, the number of days after the purchase the rebate will become available to redeem, the number of days that will be given to the customer to redeem the rebate after it becomes available, and whether or not the rebate is currently active. These four data points will be referred to as the “rebate_amount,” “rebates_available_in,” “rebates_expire_in,” and “is_active” respectively, wherein:
   i. The data collected via this interface may vary depending on the implementation and on the type of listing. For example, a feedback rebate for a dental procedure may be redeemed (i.e., reviewed) by the customer the same day the service was performed. Therefore, the “rebates available in” value may be set to zero for this type of listing. In another example, a t-shirt sold online may take a few days to be delivered and then the customer may need a few more days to use it and form an opinion. In this case, the rebates available in value may be set to several days; and
   ii. External IDs (“external id”) may also be added to the feedback rebate settings to represent the product's listings on external systems 150, such as e-commerce platforms. External systems 150 may be integrated with the reputation network server 120 or provide an interface 152 for the reputation network server 120 and its users to access data about products, customers, and orders stored on the external system's 150 servers.
b) Updating feedback rebate settings 1420, wherein the reputation network receives the feedback rebate settings data and stores it in the database.

In a related embodiment, to simplify the disclosure and allow for some variability in design, we may assume that every product listing needs only one set of feedback rebate settings regardless of its integrations with external systems 150. In this case, the feedback rebate settings data, including the external id(s), if any, can be stored directly on the listing record. If there was a need, for example, to have different feedback rebate settings for different external systems 150, then a person skilled in the art may decide to abstract the feedback rebate settings into a separate object with a one-to-many relationship to its parent listing.

In a further related embodiment, a common way to extend the functionality of a system is to abstract one or more related data points, previously stored on one object, into a new object. Such abstractions create new relationships between data objects and are well-known solutions in the art of systems design. Some implementation examples using abstractions were demonstrated previously in this disclosure. However, with every abstraction, the system becomes more complex and harder to maintain. Possible implementation options also increase exponentially with every abstraction. Hence, the goal of this disclosure is to present a minimally complex working solution that can be reasonably extended with more refined abstractions in the future without departing from the principles of the invention.

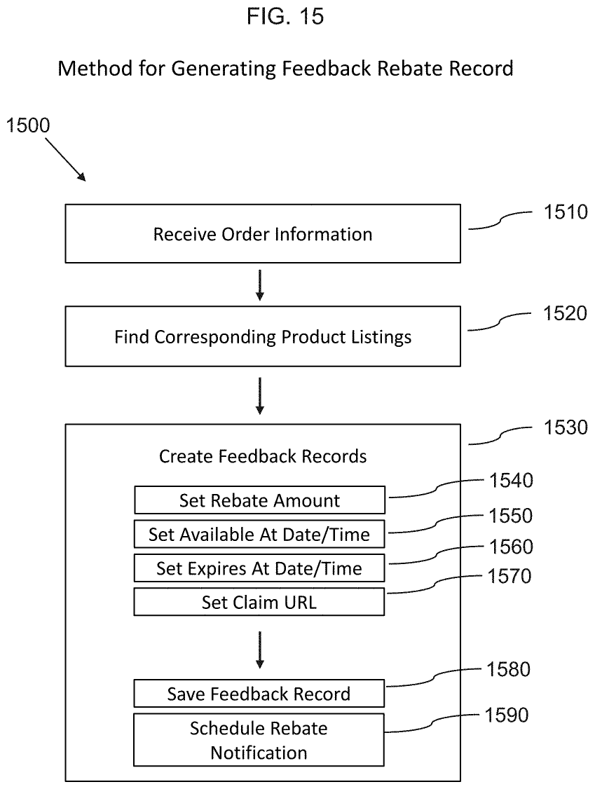

In another related embodiment, FIG. 15 shows a method diagram for generating feedback rebate instances based on the received customer order information and the feedback rebate offer settings of the purchased product listings, the method for generating feedback a feedback rebate record 1500, including:
a) Receiving order information 1510, wherein the reputation network server 120 receives an order object containing a list of purchased products, quantities, and other order information from an external system 150. In other cases, this information may come from a web-form, inbound email, or any other interface as long as it is in a computer-readable format (e.g., JSON, XML, HTML, TXT, CSV) and contains at least the product identifiers, such as the listing IDs or external IDs that could be used in a database query to find corresponding listing records stored on the reputation network server(s) 120. The order object may include other useful information, such as quantities of the products purchased and the customer's contact information.

In a further related simplified example embodiment, a JSON-formatted order object can be defined as:

```
{“order_id”: “0001”,
  “customer_name”: “Jon Doe”,
  “customer_email”: “jon.doe@example.com”,
  “created_at”: 2018-10-30T13:45:30, “products”:
{“product”:
[{“id”: “1001”, “name”: “t-shirt 1”, “quantity”: “1”},
{“id”: “1002”, “name”: “t-shirt 2”, “quantity”: “2”}]}}
```

In a further related embodiment, the method for generating feedback a feedback rebate record 1500 can further include: finding corresponding product listings 1520, wherein the reputation network server 120 performs a query for “active” listings where the external IDs match the product identifiers (e.g., “1001”, “1002”) from the order. In other words, the reputation network server 120 finds the listing records of purchased products.

In a yet further related example embodiment, an SQL query can be defined as:
a) SELECT*FROM Listings WHERE is_active=“true” AND external_id IN (“1001”, “1002”).

In a further related embodiment, the method for generating feedback a feedback rebate record 1500 can further include:
a) Creating feedback records 1530, the reputation network system iterates through the list of listing records found in the previous block and, according to each listing's feedback rebate setting, creates a feedback record and sets its feedback rebate instance data. To describe this process, a common in Object-Oriented Programming (OOP) dot-notation syntax will be used. Each found listing object will be assigned to the variable “I,” each corresponding product in the order object will be assigned to a variable “p,” the order itself will be assigned to a variable “o,” and the new feedback record will be assigned to a variable “f.”, such that, for each listing found “I,” the feedback module 328 performs these actions:
   i. Setting the rebate amount (currency field) 1540, such that f.rebate amount=p.quantity*I.rebate amount
   ii. Setting available_at (date-time field) 1550:
      f.available_at =o.created_at +I.rebates_available_in (number of days)
   iii. Setting expires_at (date-time field) 1560:
      f.expires_at =f.available_at +I.rebates_expire_in (number of days)
   iv. Setting unique claim url (encrypted field) 1570, by using an encryption method of choice to generate a unique uniform resource locator (URL) string that can only be decrypted and verified by the reputation network server 120. The decrypted claim url should at least contain the information identifying the feedback record it is related to (e.g., feedback record ID).
   v. Saving feedback record 1580, by executing a save function: f.save;
      Scheduling rebate notification 1590, wherein an automated feedback rebate notification is scheduled to be sent to the customer on f.available_at date-time, such that the automated feedback rebate notification includes the claim_url (e.g., “Review” button). Scheduling automated notifications can be achieved using any time-based job scheduler, such as Cron.
      The purpose of the claim_url is to give the individual who possesses it the right to redeem the corresponding rebate or send it to someone else, for example if the product was purchased as a gift.

In other related embodiments, the claim_url may be substituted for a token or a code to enter into a web-form in order to claim the ownership of the rebate. The claim_url or a token may be encoded into a scannable barcode or a QR code, printed, and inserted into a sealed package, so only the customer can use it to claim the rebate. An action, such as an email reply from customer's email could also serve as the claim of ownership. In certain circumstances, the reputation network system itself may automatically assign the ownership if it finds matching user account record to the customer information specified in the order object. In short, many possible schemas could be employed to securely verify a token or a URL and assign the ownership of the feedback rebate to the person who possesses it. The encrypted claim_url is used in the present implementation.

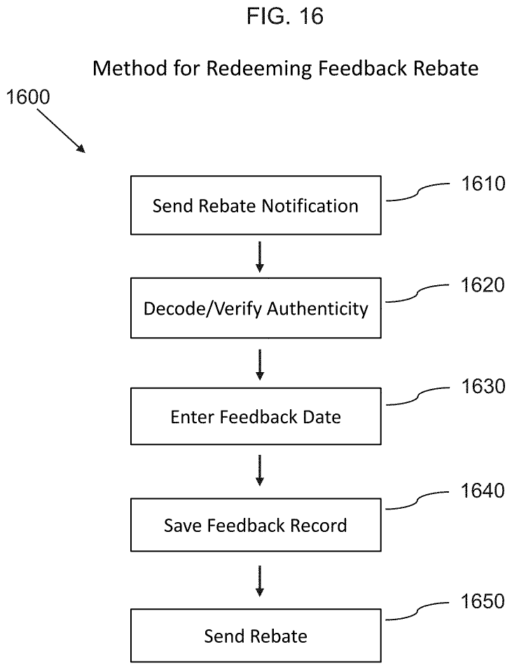

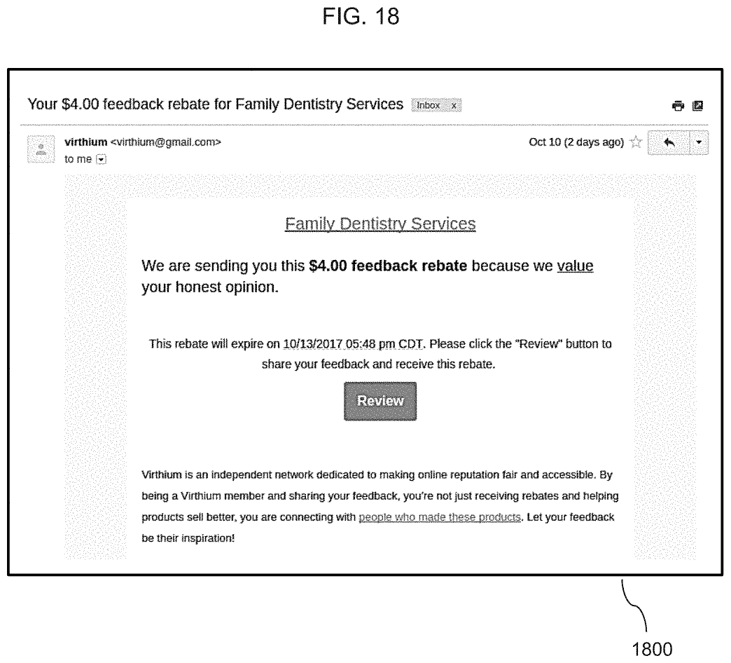

In another related embodiment, FIG. 16 shows a process diagram for redeeming the feedback rebate by a customer using the reputation network system 100, the method for redeeming feedback rebate 1600 including:
a) Sending rebate notification 1610, wherein the reputation network system 120 sends the scheduled rebate notification 1800 (as shown in FIG. 18) to the customer containing the claim_url, for example in the form of a “Review” button. Assuming the customer wants to redeem the feedback rebate, they click the “Review” button (i.e., claim_url). At this point, the customer is asked to log in or sign up for an authenticated User account on the reputation network server 120;
b) Authenticating claim uniform resource locator 1620, wherein the reputation network server 120 decodes and verifies the claim_url. The decoded URL should contain at least the identifier of the related feedback record. Once the claim_url's authenticity has been verified, the user is automatically assigned as the owner of the feedback rebate by means of updating the feedback record's owner ID with the current User's record ID, according to the present implementation. In other implementations, the User may be presented with a choice to claim the ownership, leave it unclaimed, or to transfer the ownership to another user;
c) Entering feedback date 1630, wherein the reputation network server 120 provides the interface (e.g., web-form, API) for entering feedback data, such as the satisfaction rating and the comment. An example of a review web-form 1100 is illustrated in FIG. 11. In other implementations, this interface may include other fields such as for example ratings for specific product features, selectable drop-down choices defined by the business, and net promoter scores (NPS), etc.;
d) Saving feedback record 1640, wherein the reputation network server 120 saves the feedback data in the database and triggers other updates and actions, as described earlier in relation to FIG. 12; and
e) Sending rebate 1650, wherein the reputation network system sends the customer a confirmation email and a partial refund equal to the redeemed rebate value.

In a related embodiment, methods used for charging listing owners and sending feedback rebate refunds to customers can depend on the implementation of the payment module 321 (shown FIG. 3). A wide variety of methods to facilitate transactions can be devised by a person skilled in the art, and may use multiple solutions depending on the use case. Companies, such as STRIPE™ and PAYPAL™, provide APIs and well-documented guides to enable developers to quickly implement any desired solution. Some solutions would be better suited for use in the reputation network system 100 than others. It wouldn't be possible to describe and analyze every possible implementation; however, a few examples will be presented so that the person skilled in the art could devise an appropriate for their use case solution.

In a related embodiment, sending a refund to a customer would typically occur in two steps: 1—charging the listing owner for the amount of the rebate and 2-sending the refund to the customer. Note that these steps may be sequential or done in parallel.

In a further related embodiment, to facilitate the first step (charging the listing owner), the listing owner can provide a payment method, for example, a credit card. The payment method information, such as the encrypted credit card number, billing address, and expiration date, can be stored directly on the listing record, or a record of another database object (e.g., “Payment Method”) that can “have many” listings via a reference (e.g., payment method id). If adding multiple payment methods to one listing is desired, a joint object may be introduced. When the customer redeems the rebate, the payment module 321 will automatically use the payment information to make a charge.

The listing owner may deposit a certain amount of funds up-front and then use that balance to send refunds. Alternatively, the listing owner may provide access to his or her account on an external system 150, such as an e-commerce merchant account, such that the reputation network server 120 would be able to make charges or send refunds to customers automatically on his or her behalf.

In another further related embodiment, to facilitate the second step (sending the refund to the customer), the reputation network server 120 can implement and provide options for customers to choose how they wish to receive their refunds (e.g., check, bank deposit, bitcoin, PayPal, gift card). Many reliable and well-documented solutions are available to send money electronically as well as physically.

If the customer selects no option, the reputation network system can use the default option, such as using customer's email or phone number to send the money via PayPal or a similar service. The default option could also be storing the value of the refund on the user's account balance in the reputation network system's user data table 130 and wait until the user either withdraw the money or applies the balance to future purchases.

In a related embodiment of the payment module 321, multiple methods can be used to send a refund to customers. The method to use in any given instance depends on the situation. For example, if the listing owner provided access to their merchant account on an external system 150 allowing the reputation network server 120 to send refunds on his or her behalf, then the payment module 321 would send an authenticated HTTP request with the refund object (e.g., containing information about the order, the refund amount, and authentication headers) to the external system to process that refund. This implementation is typically preferred because the refund is sent to the same payment method the customer used for the purchase and the refund transaction is typically processed without incurring transaction fees. If the rebate cannot be sent through an external system 150 as a refund, the listing owner's credit card and customer's PayPal account, for example, can then be used to send the money.

In an embodiment, an existing social network or an e-commerce platform can incorporate parts or all of the reputation network system 100 by introducing the necessary objects and their relationships.

For example, since social networks already have a version of a User object 130 and a way to relate user feedback (e.g., “likes”, shares, comments) to content, and by reference to users who are “tagged” on that content, it would be possible to introduce the listing module 324 and listing data object 132, to represent things other than content, and modify the “tagging” process to represent contributors and their contributions. With these modifications, a user would have an opportunity to post a listing of their product or service on a social network, “tag” individual users as contributors and receive feedback from other users. Since “likes,” shares and followers are not designed for non-content related items, they are not well suited to generate or represent the reputation of products and services. Therefore, a version of the feedback module 328 and feedback data object 136 should also be implemented, as well as the feedback rebate method, to achieve better results.

Other reputation providers, such as e-commerce platforms (e.g. AMAZON™, EBAY™), independent review websites (e.g. YELP™, TRUSTPILOT™), and user generated content (UGC) apps (e.g., YOTPO™, FEEFO™), among many other examples, typically already have a version of listing 132 and feedback 136 objects, but lack the contribution module 326 and contribution data object 134 and the feedback rebate method to generate high-quality feedback and attribute it to contributors. By implementing these solutions, a reputation provider can increase the quality of feedback and the value of that feedback to the business.

The reputation network system 100 and its various components may enforce certain validation rules to guide its users and prevent harmful or unauthorized use. A few examples will be presented below. These “validation rule” examples are expressed in natural language herein, but within the reputation network system 100 they would be expressed using a computer programming language. This disclosure is not written specifically for any particular computer programming language; therefore, the person skilled in the art can take liberty in choosing their preferred technology to implement these validation rules.

Using the Model View Controller (MVC) methodology, these validation rules can be implemented in the model of each object presented in FIG. 4. When any of these rules are violated by a user or an external system 150, the reputation network server 120 can display an appropriate error or warning message that would appear on the web-page or in the HTTP response. For example, if a review rating is required to submit a review, but the user didn't provide the rating, the form wouldn't submit and an error message reading “Please select a rating” would be presented to the user.

In a related embodiment, user validation rules can include:
a) A user must provide first name, last name, email, phone number, and password in order to sign-up;
b) A user's email and phone number must be unique (i.e., two members on the reputation network system 100 cannot have the same email or phone number); and/or
c) To update his or her account information and login credentials the user must be authenticated.

In another related embodiment, listing validation rules can include:
a) When creating a listing, a user must provide the title and description;
b) Only a listing owner can update, delete, and restore the listing; and/or
c) A listing's feedback rebate offer can be active only if the listing owner has provided a viable method to send the refund (e.g., credit card, external system 150 integration).

In yet another related embodiment, contribution validation rules can include:
a) A contributor must provide a role and a contribution description in order to accept a role invitation;
b) Only an individual possessing a unique and valid invitation URL can accept the role invitation; and/or
c) Once the contribution is accepted, only the contributor can edit, delete, or restore it.

In yet another related embodiment, feedback validation rules can include:
a) A feedback record can only be created if the listing is specified;
b) A feedback record can only be created if the listing it belongs to has a valid method of sending refunds;
c) A feedback record can only be created if the listing it belongs to has an active feedback rebate offer;
d) A feedback record must always contain the rebate amount, the availability date, the expiration date, and the customer identifier (e.g., customer's user id, email, phone number);
e) When updating a feedback record, the rating and the comment must be specified;
f) Only an individual possessing a unique and valid claim URL can submit (i.e., edit for the first time providing the review data) feedback (e.g., review);
g) Only the user who claimed the rebate in the past (i.e., became the owner of the feedback record) can submit or edit the feedback record;
h) A feedback record can only be claimed before the expiration date;
i) A feedback record must be claimed (i.e., owner id must be present) before the review (i.e., rating and comment) can be submitted (i.e., review data provided for the first time); and/or
j) Submitted feedback record can only be deleted if the listing it belongs to is being deleted.

These validation rules are examples according to some embodiments. Other rules can be added, and existing rules changed without departing from the principles of the reputation network system 100.

In an embodiment, as shown in FIG. 1, a reputation network system 100 can include:
a) a reputation network server 120; and
b) at least one reputation network device 102;
wherein the reputation network server 120 can be configured to enable a listing owner 180 user to create and store a product listing 433 for a product, in communication via the at least one reputation network device 102; wherein the product listing 433 comprises product information and a feedback rebate offer;
wherein the reputation network server 120 is configured to enable a contributor user 180 to create and store a contribution record 435 in relation to the product listing 433, in communication via the at least one reputation network device 102; wherein the contribution record 435 comprises contribution information including a contribution reputation rank 484;
wherein the reputation network server 120 is configured to create and store a product review 437 on the reputation network server 120, in communication via the at least one reputation network device 102; and
wherein the consumer user 180 is enabled to redeem the feedback rebate offer and receive a corresponding feedback rebate after providing the product review 437.

In a further related embodiment, the reputation network server 120 can be configured to enable a consumer user 180 to process a purchase transaction related to the product (such as purchasing the product). Processing the purchase transaction on the reputation network server 120 can include processing an entire purchase transaction or validating an external purchase on the reputation network server 120, for example by processing a proof of purchase issued by an external ecommerce system 150.

In a further related embodiment, as shown in FIG. 4, the reputation network server 120 can further include a reputation database 400, including:
a) a listing data entity 132, including product listing records 433, which include the product listing 433;
b) a contribution data entity 134, which includes contribution records 435, each relating a contribution role 474 for a corresponding contributing user 431, 180 to a corresponding product listing 433, wherein there is a one-to-many relationship between the product listing records 433 and the contribution records 435;
c) a feedback data entity 136, which includes feedback records 437 (i.e. product reviews 437) for storing feedback of the consumer user in relation to product listing records 433;
   wherein there is a one-to-many relationship between the product listing records 433 and the feedback records 437; and
d) a user data entity 130, including user information records 431,
   wherein there is a one-to-many relationship between the user information records 431 and the product listing records 433,
   wherein there is a one-to-many relationship between the user information records 431 and the contribution records 435, and
   wherein there is a one-to-many relationship between the user information records 431 and the feedback records 437.

In a yet further related embodiment, as shown in FIG. 13, the reputation database 1300 can further include:
a role entity 137, which stores role records 438, each including an average reputation rank;
   such that each role record 438 can be related to multiple contribution records 435, multiple product listing records 433, and multiple user information records 431.

In a yet further related embodiment, the reputation database 1300 can further include:
a joint role tag entity 135, which stores role tag records 436, which link role records 436 with contribution records 435, product listing records 433, and user information records 431;
wherein there is a one-to-many relationship between the product listing records 433 and the role tag records 436;
wherein there is a one-to-many relationship between the contribution records 435 and the role tag records 436;
wherein there is a one-to-many relationship between the user information records 431 and the role tag records 436; and
wherein there is a one-to-many relationship between the role records 438 and the role tag records 436.

In a related embodiment, the reputation network server 120 can be configured to calculate a relative weight for the product review 437, wherein the relative weight can be a weighted measure of at least one consumer interaction (including business transactions) related to the product review (i.e. all related interactions/transaction(s)), wherein the at least one interaction (or business transaction) can include that the consumer user purchases the product. An interaction (or business transaction) can include information such as the amount paid by the consumer for the product, the amount purchased, frequency of purchases, length of time until delivery, warranty terms, product condition at purchase, length of use, relative reputation rank of the consumer (e.g., how helpful her reviews were for other similar products as rated by other consumers), consumer's biases and conflicts of interest (e.g., the consumer is also a contributor to a competing product), or any number of other variables that could be useful for weighing the consumer's review.

In a further related embodiment, the relative weight can be equal to a number of products purchased by the consumer user 180 in relation to the product review 437, the frequency of purchases, amount of money spent, or other measures or variables associated with interactions or business transactions related to the product review 437.

In another related embodiment, the reputation network server 120 can be configured to calculate a product listing relative reputation rank 482 as a weighted measure of product ratings 486 of product reviews 437 related to the product listing 433.

In a further related example embodiment, the reputation network server 120 can be configured to calculate the product listing relative reputation rank 482, such that

the product listing relative reputation rank=(v/(v+m))×r+(m/(v+m))×c
wherein r=a mean value 492 of product ratings 486 of product reviews 437 for the product listing 433;
   v=a number of reviews 437 for the product listing 433 measured by relative weight;
   m=an amount of reviews 437 required to reach statistical significance measured by relative weight; and
   c=a mean value of product ratings 486 of product reviews 437 for similar product listings 433.

In yet another related embodiment, the reputation network server 120 can be configured to calculate a contribution relative reputation rank 484 as a weighted measure of relative reputation ranks 482 of product listings 433 that are related to the contribution record 435 for the contributor user 431.

In a further related embodiment, the reputation network server 120 can be configured to calculate the contribution relative reputation rank 484, such that

the contribution relative reputation rank=(v/(v+m))×r+(m/(v+m))×c
wherein r=a mean value of product ratings 486 of product reviews 437 for product listings 433 that are related to the contribution record 435;
   v=an aggregated relative weight of reviews 437 that are related to the contribution record 435;
   m=an amount of reviews 437 required to reach statistical significance measured by relative weight; and
   c=a mean value for product ratings 486 of product reviews 437 for product listings 433 related to similar contribution records 435.

Thus, in related embodiments, the reputation network system 100 enables multi-level, transitive relationships (e.g., one contributor user 180 has-many reviews 437 through her contribution records 435 that belong to listings 433, which have-many reviews). In other words, a listing 433 (e.g., product 433) earns reputation not only for the product (as is the case everywhere today) but also for each person 180 who contributed. This reputation transitively flows through first, the listing 433, then all the contribution records 435 related to that listing, and finally to the individual contributor users 180 (contributors 180), who are related to those contribution records 435. In an alternative view, each contributing user 180 has many customers 180 (i.e. consumer users 180) through contribution records 435, related to listing records 433, related to customer reviews 437, related to customers 180. Similarly, each customer user 180 has many contributors 180.

In a related embodiment, as shown in FIGS. 9 and 20, the reputation network device 102 can be configured with a graphical user interface to show a combined presentation of a product listing 433 and at least one related contributor user 431, and optionally at least one related product review 437, which is related to the product listing 433.

In a related embodiment, as shown in FIGS. 10 and 19, the reputation network device 102 can be configured with a graphical user interface to show a combined presentation of a user profile 431 and at least one related contribution record 435, and optionally at least one related product review 437 created by the user 180.

In a further related embodiment, the reputation network server 100 can be configured to enable a user 180, as well as an internal or external system 150, to query for a list of contributing users 180 and order the list by the contribution relative reputation rank. Thereby, the reputation network system 100 can enable a user 180 or external system 150 to do a search to find the best (or worst) contributors 180 based on the relative reputation rank their products received.

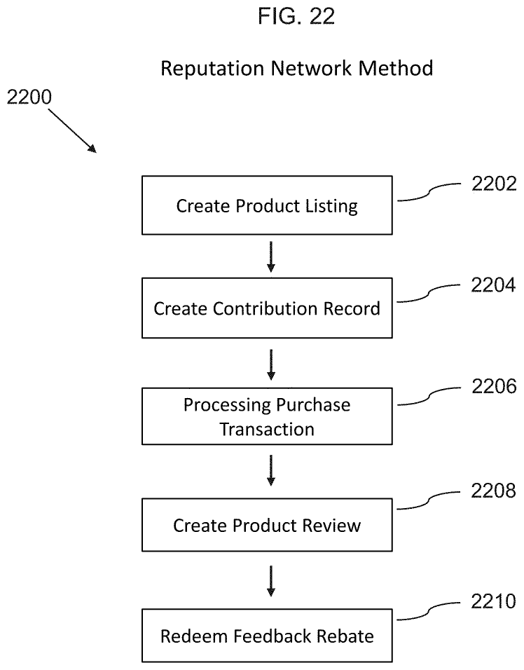

In an embodiment, as shown in FIG. 22, a reputation network method 2200, can include:
a) Creating a product listing for a product 2202, wherein the product listing includes product information and a feedback rebate offer, wherein the product listing is stored in a reputation database;
b) Creating a contribution record in relation to the product listing 2204, wherein the contribution record includes contribution information, wherein the contribution record is stored in the reputation database;
c) Processing a purchase transaction 2206 related to the product listing, which for example can include performing an entire purchase transaction or validating a purchase of the product associated with the business listing;
d) Creating a product review for the product 2208, wherein the consumer user provides the product review; and
e) Redeeming the feedback rebate offer 2210, such that the consumer user receives a corresponding feedback rebate in relation to the business transaction, after providing the product review.

In a further related embodiment, completing a business transaction 2206 can include that the consumer user purchases the product. In related embodiments, the purchase may be made directly in the reputation network system 100 or it may be a manual cash transaction, which is later recorded in the reputation network system 100.

In related embodiments, the reputation network device 102 can include configurations as:
a) A web application, executing in a Web browser;
b) A tablet app, executing on a tablet device, such as for example an Android or iOS tablet device;
c) A mobile app, executing on a mobile device, such as for example an ANDROID™ phone or IPHONE™, or any wearable mobile device;
d) A desktop application, executing on a personal computer, or similar device;
e) An embedded application, executing on a processing device, such as for example a smart TV, a game console or other system.

It shall be understood that an executing instance of an embodiment of the reputation network system 100, as shown in FIG. 1, can include a plurality of reputation network devices 102, which are each tied to one or more users 180.

An executing instance of an embodiment of the reputation network system 100, as shown in FIG. 1, can similarly include a plurality of reputation network servers 120.

FIGS. 1-21 are block diagrams and flowcharts, methods, devices, systems, apparatuses, and computer program products according to various embodiments of the present invention. It shall be understood that each block or step of the block diagram, flowchart and control flow illustrations, and combinations of blocks in the block diagram, flowchart and control flow illustrations, can be implemented by computer program instructions or other means. Although computer program instructions are discussed, an apparatus or system according to the present invention can include other means, such as hardware or some combination of hardware and software, including one or more processors or controllers, for performing the disclosed functions.

In this regard, FIGS. 1, 2, and 3 depict the computer devices of various embodiments, each containing several of the key components of a general-purpose computer by which an embodiment of the present invention may be implemented. Those of ordinary skill in the art will appreciate that a computer can include many components. However, it is not necessary that all of these generally conventional components be shown in order to disclose an illustrative embodiment for practicing the invention. The general-purpose computer can include a processing unit and a system memory, which may include various forms of non-transitory storage media such as random access memory (RAM) and read-only memory (ROM). The computer also may include nonvolatile storage memory, such as a hard disk drive, where additional data can be stored.

FIG. 1 shows a depiction of an embodiment of the reputation network system 100, including the reputation network server 120, and the reputation network device 102. In this relation, a server shall be understood to represent a general computing capability that can be physically manifested as one, two, or a plurality of individual physical computing devices, located at one or several physical locations. A server can for example be manifested as a shared computational use of one single desktop computer, a dedicated server, a cluster of rack-mounted physical servers, a datacenter, or network of datacenters, each such datacenter containing a plurality of physical servers, or a computing cloud, such as AMAZON EC2™ or MICROSOFT AZURE™.

It shall be understood that the above-mentioned components of the reputation network server 120 and the reputation network device 102 are to be interpreted in the most general manner.

For example, the processors 202 302 can each respectively include a single physical microprocessor or microcontroller, a cluster of processors, a datacenter or a cluster of datacenters, a computing cloud service, and the like.

In a further example, the non-transitory memory 212 and the non-transitory memory 306 can each respectively include various forms of non-transitory storage media, including random access memory and other forms of dynamic storage, and hard disks, hard disk clusters, cloud storage services, and other forms of long-term storage. Similarly, the input/output 204 and the input/output 304 can each respectively include a plurality of well-known input/output devices, such as screens, keyboards, pointing devices, motion trackers, communication ports, and so forth.

Furthermore, it shall be understood that the reputation network server 120 and the reputation network device 102 can each respectively include a number of other components that are well known in the art of general computer devices, and therefore shall not be further described herein. This can include system access to common functions and hardware, such as for example via operating system layers such as WINDOWS™, LINUX™, and similar operating system software, but can also include configurations wherein application services are executing directly on server hardware or via a hardware abstraction layer other than a complete operating system.

An embodiment of the present invention can also include one or more input or output components, such as a mouse, keyboard, monitor, and the like. A display can be provided for viewing text and graphical data, as well as a user interface to allow a user to request specific operations. Furthermore, an embodiment of the present invention may be connected to one or more remote computers via a network interface. The connection may be over a local area network (LAN) wide area network (WAN), and can include all of the necessary circuitry for such a connection.

In a related embodiment, the reputation network device 102 communicates with the reputation network server 120 over a network 110, which can include the general Internet, a Wide Area Network or a Local Area Network, or another form of communication network, transmitted on wired or wireless connections. Wireless networks can for example include Ethernet, Wi-Fi, BLUETOOTH™, ZIGBEE™, and NFC. The communication can be transferred via a secure, encrypted communication protocol.

Typically, computer program instructions may be loaded onto the computer or other general-purpose programmable machine to produce a specialized machine, such that the instructions that execute on the computer or other programmable machine create means for implementing the functions specified in the block diagrams, schematic diagrams or flowcharts. Such computer program instructions may also be stored in a computer-readable medium that when loaded into a computer or other programmable machine can direct the machine to function in a particular manner, such that the instructions stored in the computer-readable medium produce an article of manufacture including instruction means that implement the function specified in the block diagrams, schematic diagrams or flowcharts.

In addition, the computer program instructions may be loaded into a computer or other programmable machine to cause a series of operational steps to be performed by the computer or other programmable machine to produce a computer-implemented process, such that the instructions that execute on the computer or other programmable machine provide steps for implementing the functions specified in the block diagram, schematic diagram, flowchart block or step.

Accordingly, blocks or steps of the block diagram, flowchart or control flow illustrations support combinations of means for performing the specified functions, combinations of steps for performing the specified functions and program instruction means for performing the specified functions. It will also be understood that each block or step of the block diagrams, schematic diagrams or flowcharts, as well as combinations of blocks or steps, can be implemented by special purpose hardware-based computer systems, or combinations of special purpose hardware and computer instructions, that perform the specified functions or steps.

As an example, provided for purposes of illustration only, a data input software tool of a search engine application can be a representative means for receiving a query including one or more search terms. Similar software tools of applications, or implementations of embodiments of the present invention, can be means for performing the specified functions. For example, an embodiment of the present invention may include computer software for interfacing a processing element with a user-controlled input device, such as a mouse, keyboard, touch screen display, scanner, or the like. Similarly, an output of an embodiment of the present invention may include, for example, a combination of display software, video card hardware, and display hardware. A processing element may include, for example, a controller or microprocessor, such as a central processing unit (CPU), arithmetic logic unit (ALU), or control unit.

Here has thus been described a multitude of embodiments of the reputation network system 100, and methods related thereto, which can be employed in numerous modes of usage.

The many features and advantages of the invention are apparent from the detailed specification, and thus, it is intended by the appended claims to cover all such features and advantages of the invention, which fall within the true spirit and scope of the invention.

For example, alternative embodiments can reconfigure or combine the components of the reputation network server 120 and the reputation network device 102. The components of the reputation network server 120 can be distributed over a plurality of physical, logical, or virtual servers. Parts or all of the components of the reputation network device 102 can be configured to operate in the reputation network server 120, whereby the reputation network device 102 for example can function as a thin client, performing only graphical user interface presentation and input/output functions. Alternatively, parts or all of the components of the reputation network server 120 can be configured to operate in the reputation network device 102.

Many such alternative configurations are readily apparent, and should be considered fully included in this specification and the claims appended hereto. Accordingly, since numerous modifications and variations will readily occur to those skilled in the art, the invention is not limited to the exact construction and operation illustrated and described, and thus, all suitable modifications and equivalents may be resorted to, falling within the scope of the invention.

What is claimed is:

1. A reputation network system, comprising:
a) a reputation network server; and
b) at least one reputation network device;
wherein the reputation network server is configured to enable a listing owner user to create and store a product listing for a product, in communication via the at least one reputation network device; wherein the product listing comprises a feedback rebate offer;
wherein the reputation network server is configured to enable a contributor user to create and store a contribution record in relation to the product listing, in communication via the at least one reputation network device; wherein the contribution record comprises contribution information;
wherein the reputation network server is configured to enable a consumer user to create and store a product review on the reputation network server, in communication via the at least one reputation network device; and
wherein the reputation network server is configured to enable the consumer user to redeem the feedback rebate offer and receive a corresponding feedback rebate after providing the product review.

2. The reputation network system of claim 1, wherein the reputation network server is configured to enable the consumer user to process a purchase transaction related to the product.

3. The reputation network system of claim 1, wherein the reputation network server further comprises a reputation database, comprising:
a) a listing data entity, which comprises product listing records, which comprise the product listing;
b) a contribution data entity, which comprises contribution records, each relating a contribution role for a corresponding contributing user to a corresponding product listing,
wherein there is a one-to-many relationship between the product listing records and the contribution records;
c) a feedback data entity, which comprises feedback records for storing feedback of the consumer user in relation to the product listing records, wherein there is a one-to-many relationship between the product listing records and the feedback records; and
d) a user data entity, comprising user information records,
wherein there is a one-to-many relationship between the user information records and the product listing records,
wherein there is a one-to-many relationship between the user information records and the contribution records, and
wherein there is a one-to-many relationship between the user information records and the feedback records.

4. The reputation network system of claim 3, wherein the reputation database further comprises:
a role entity, which comprises role records, each comprising an average reputation rank;
such that each role record is related to multiple contribution records, multiple product listing records, and multiple user information records.

5. The reputation network system of claim 4, wherein the reputation database further comprises:
a joint role tag entity, which comprises role tag records, which link role records with contribution records, listing records, and user information records;
wherein there is a one-to-many relationship between the listing records and the role tag records;
wherein there is a one-to-many relationship between the contribution records and the role tag records;
wherein there is a one-to-many relationship between the user information records and the role tag records; and
wherein there is a one-to-many relationship between the role records and the role tag records.

6. The reputation network system of claim 1, wherein the reputation network server is configured to calculate a relative weight for the product review, wherein the relative weight is equal to a weighted measure of at least one consumer interaction related to the product review.

7. The reputation network system of claim 6, wherein the relative weight is equal to a number of products purchased by the consumer user in relation to the product review.

8. The reputation network system of claim 1, wherein the reputation network server is configured to calculate a product listing relative reputation rank as a weighted measure of product ratings of product reviews related to the product listing.

9. The reputation network system of claim 8, wherein the reputation network server is configured to calculate the product listing relative reputation rank, such that:
the product listing relative reputation rank=(v/(v+m))×r+(m/(v+m))×c;
wherein r=a mean value of product ratings of product reviews for the product listing;
v=a number of reviews for the product listing measured by relative weight;
m=an amount of reviews required to reach statistical significance measured by relative weight; and
c=a mean value of product ratings of product reviews for similar product listings.

10. The reputation network system of claim 1, wherein the reputation network server is configured to calculate a contribution relative reputation rank as a weighted measure of relative reputation ranks of product listings that are related to the contribution record.

11. The reputation network system of claim 10, wherein the reputation network server is configured to calculate the contribution relative reputation rank, such that:
the contribution relative reputation rank=(v/(v+m))×r+(m/(v+m))×c;
wherein r=a mean value of product ratings of product reviews for product listings that are related to the contribution record;
v=an aggregated relative weight of reviews that are related to the contribution record;
m=an amount of reviews required to reach statistical significance measured by relative weight; and
c=a mean value for product ratings of product reviews for product listings related to similar contribution records.

12. The reputation network system of claim 1, wherein the reputation network device is configured with a graphical user interface to show a combined presentation of the product listing and at least one related contributor user.

13. The reputation network system of claim 12, wherein the combined presentation of the product listing further comprises at least one related product review.

14. The reputation network system of claim 1, wherein the reputation network device is configured with a graphical user interface to show a combined presentation of the contributing user and at least one related contribution record.

15. A reputation network system, comprising:
a reputation network server, which is configured to enable a listing owner user to store a product listing for a product;
wherein the product listing comprises a feedback rebate offer;
wherein the reputation network server is configured to enable a contributor user to create and store a contribution record in relation to the product listing, wherein the contribution record comprises contribution information;
wherein the reputation network server is configured to enable a consumer user to create and store a product review on the reputation network server; and
wherein the reputation network server is configured to enable the consumer user to redeem the feedback rebate offer and receive a corresponding feedback rebate after providing the product review.

16. The reputation network system of claim 15, wherein the reputation network server further comprises a reputation database, comprising:
a) a listing data entity, which comprises product listing records, which comprise the product listing;
b) a contribution data entity, which comprises contribution records, each relating a contribution role for a corresponding contributing user to a corresponding product listing,
wherein there is a one-to-many relationship between the product listing records and the contribution records;
c) a feedback data entity, which comprises feedback records for storing feedback of the consumer user in relation to the product listing records wherein there is a one-to-many relationship between the product listing records and the feedback records; and
d) a user data entity, comprising user information records,
wherein there is a one-to-many relationship between the user information records and the product listing records,
wherein there is a one-to-many relationship between the user information records and the contribution records, and
wherein there is a one-to-many relationship between the user information records and the feedback records.

17. The reputation network system of claim 16, wherein the reputation database further comprises:
a role entity, which comprises role records, each comprising an average reputation rank;
such that each role record is related to multiple contribution records, multiple product listing records, and multiple user information records.

18. The reputation network system of claim 17, wherein the reputation database further comprises:
a joint role tag entity, which comprises role tag records, which link role records with contribution records, listing records, and user information records;
wherein there is a one-to-many relationship between the listing records and the role tag records;
wherein there is a one-to-many relationship between the contribution records and the role tag records;
wherein there is a one-to-many relationship between the user information records and the role tag records; and
wherein there is a one-to-many relationship between the role records and the role tag records.

19. The reputation network system of claim 15, wherein the reputation network server is configured to calculate a relative weight for the product review, wherein the relative weight is equal to a weighted measure of at least one consumer interaction related to the product review.

20. The reputation network system of claim 15, wherein the reputation network server is configured to calculate a product listing relative reputation rank as a weighted measure of product ratings of product reviews related to the product listing.

21. The reputation network system of claim 15, wherein the reputation network server is configured to calculate a contribution relative reputation rank as a weighted measure of relative reputation ranks of product listings that are related to the contribution record.

22. A reputation network method, comprising:
a) creating a product listing for a product, wherein the product listing comprises a feedback rebate offer, wherein the product listing is stored in a reputation database;
b) creating a contribution record in relation to the product listing, wherein the contribution record comprises contribution information, wherein the contribution record is stored in the reputation database;
c) creating a product review for the product, wherein a consumer user provides the product review; and
d) redeeming the feedback rebate offer, such that the consumer user receives a corresponding feedback rebate, after providing the product review.

23. The reputation network method of claim 22, further comprising processing a purchase transaction related to the product listing.

24. The reputation network method of claim 22, wherein the reputation database, comprises:
a) a listing data entity, which comprises product listing records, which comprise the product listing;
b) a contribution data entity, which comprises contribution records, each relating a contribution role for a corresponding contributing user to a corresponding product listing,
wherein there is a one-to-many relationship between the product listing records and the contribution records;
c) a feedback data entity, which comprises feedback records for storing feedback of the consumer user in relation to the product listing records wherein there is a one-to-many relationship between the product listing records and the feedback records; and
d) a user data entity, comprising user information records,
wherein there is a one-to-many relationship between the user information records and the product listing records,
wherein there is a one-to-many relationship between the user information records and the contribution records, and
wherein there is a one-to-many relationship between the user information records and the feedback records.

25. The reputation network method of claim 24, wherein the reputation database further comprises:
a role entity, which comprises role records, each comprising an average reputation rank;
such that each role record is related to multiple contribution records, multiple product listing records, and multiple user information records.

26. The reputation network method of claim 25, wherein the reputation database further comprises:
a joint role tag entity, which comprises role tag records, which link role records with contribution records, listing records, and user information records;
wherein there is a one-to-many relationship between the listing records and the role tag records;
wherein there is a one-to-many relationship between the contribution records and the role tag records;
wherein there is a one-to-many relationship between the user information records and the role tag records; and
wherein there is a one-to-many relationship between the role records and the role tag records.

27. The reputation network method of claim 22, further comprising calculating a relative weight for the product review, wherein the relative weight is equal to a weighted measure of at least one consumer interaction related to the product review.

28. The reputation network method of claim 22, further comprising calculating a product listing relative reputation rank as a weighted measure of product ratings of product reviews related to the product listing.

29. The reputation network method of claim 22, further comprising calculating a contribution relative reputation rank as a weighted measure of relative reputation ranks of product listings that are related to the contribution record.
